(19) United States
(12) Patent Application Publication
(10) Pub. No.: US 2016/0104893 A1
(43) Pub. Date: Apr. 14, 2016

(54) COMPOSITION FOR ELECTRICITY STORAGE DEVICES, SLURRY FOR ELECTRICITY STORAGE DEVICES, ELECTRODE FOR ELECTRICITY STORAGE DEVICES, SEPARATOR FOR ELECTRICITY STORAGE DEVICES, AND ELECTRICITY STORAGE DEVICE

(71) Applicant: JSR CORPORATION, Tokyo (JP)

(72) Inventors: Kazuaki ITOU, Minato-ku (JP); Tomotaka SHINODA, Minato-ku (JP); Hiroyuki MIYAUCHI, Minato-ku (JP)

(73) Assignee: JSR CORPORATION, Minato-ku, Tokyo (JP)

(21) Appl. No.: 14/893,875

(22) PCT Filed: May 19, 2014
(86) PCT No.: PCT/JP14/63155

§ 371 Date: Nov. 24, 2015

(30) Foreign Application Priority Data
May 24, 2013 (JP) 2013-109728
May 24, 2013 (JP) 2013-109729

(51) Int. Cl. H01M 4/62; H01M 2/16; H01M 4/13; H01M 10/0525

(52) U.S. Cl. CPC H01M 4/628; H01M 4/623; H01M 10/0525; H01M 4/622; H01M 2/1686; H01M 2/1653; H01M 4/13

(57) ABSTRACT

An electrical storage device composition can produce an electrode and a separator that exhibit excellent blocking resistance, and can effectively prevent displacement (i.e., achieves moderate blocking) when stacking an electrode and a separator. The electrical storage device composition includes a binder, an anti-blocking agent, and a liquid medium, the content (M1 parts by mass) of the binder and the content (M2 parts by mass) of the anti-blocking agent in the electrical storage device composition satisfying the relationship “1<M1/M2<4,000”.

### TECHNICAL FIELD

The present invention relates to an electrical storage device composition (i.e., a composition used to produce an electrical storage device), an electrical storage device slurry that includes the composition, an electrical storage device electrode that is produced by applying the slurry to a collector and drying the applied slurry, an electrical storage device separator that includes a protective film that is provided on the surface thereof and produced by applying and drying the slurry, and an electrical storage device that includes at least one of the electrode and the separator.

### BACKGROUND ART

A positive electrode and a negative electrode (hereinafter may be referred to as “electrode”) used for an electrical storage device are produced by applying a mixture that includes an active material and a binder to the surface of a collector, and drying the applied mixture to form an active material layer on the surface of the collector (see JP-A-2013-030449). In recent years, a technique has been proposed that applies a mixture that includes inorganic particles and a binder to the surface of a separator, and drying the applied mixture to form a dendrite-resistant protective film on the surface of the separator. In the field of electrical storage devices, a layer that includes an active material or inorganic particles is normally provided on the surface of an electrode or a separator (see JP-A-2011-005867).

An electrical storage device may be produced by stacking a positive electrode and a negative electrode on either side of a separator (that prevents a short circuit between the positive electrode and the negative electrode), bonding the electrode to the separator, or forming the laminate (e.g., winding the laminate), placing the laminate in a container, injecting an electrolyte solution into the container, and sealing the container.

The electrode and the separator may be wound in the shape of a roll, and stored until the electrode and the separator are used to produce an electrical storage device. In such a case, blocking (i.e., slippage occurs to only a small extent at the surface of contact (hereinafter the term “blocking” has the same meaning)) may easily occur between the electrodes or between the separators. In this case, the active material may be removed from the active material layer, or the inorganic particles may be removed from the separator, for example. For example, JP-A-2007-059271 discloses a method that prevents blocking by utilizing polymer particles having a reactive functional group as an anti-blocking agent.

### SUMMARY OF INVENTION

### Technical Problem

When producing an electrical storage device, the electrode and the separator are positioned and stacked to form a laminate (electrode/separator laminate), and the laminate is formed (e.g., wound). When stacking the electrode and the separator, the electrode and the separator may be easily displaced relative to each other (i.e., it may be difficult to position the electrode and the separator) when moderate blocking does not occur between the electrode and the separator. If the electrode and the separator are displaced relative to each other, a short circuit may occur, and the electrical storage device may generate heat, for example. If strong blocking occurs between the electrode and the separator when forming (e.g., winding) the electrode/separator laminate, the active material layer may be removed (may fall). In such a case, the charge-discharge characteristics of the electrical storage device deteriorate, for example. The yield decreases due to the above phenomena when mass-producing an electrical storage device.

The technology disclosed in JP-A-2007-059271 can prevent blocking between the separators. However, since blocking between the electrode and the separator is also prevented during forming, it is difficult to solve the above problem that occurs during forming.

Several aspects of the invention may solve at least some of the above problems, and provide an electrical storage device composition that can produce an electrical storage device electrode and an electrical storage device separator that exhibit excellent blocking resistance and can effectively prevent displacement (i.e., achieve moderate blocking) when an electrode and a separator are stacked, and an electrical storage device slurry that includes the composition.

Several aspects of the invention may solve at least some of the above problems, and provide an electrical storage device electrode and an electrical storage device separator that exhibit excellent blocking resistance and can effectively prevent displacement (i.e., achieve moderate blocking) when an electrode and a separator are stacked, and an electrical storage device that includes the same.

### Solution to Problem

The invention was conceived in order to solve at least some of the above problems, and may be implemented as described below (see the following aspects and application examples).

### Application Example 1

According to one aspect of the invention, an electrical storage device composition includes:

a polymer (A) that includes a repeating unit derived from an unsaturated carboxylic ester;

a component (B) that is at least one component selected from the group consisting of a polyethylene wax, a polypropylene wax, a fatty acid amide, a fatty acid ester, and a fatty acid metal salt; and

a liquid medium,

the content (M1 parts by mass) of the polymer (A) and the content (M2 parts by mass) of the component (B) in the electrical storage device composition satisfying the relationship “1<M1/M2<4,000”.

### Application Example 2

According to another aspect of the invention, an electrical storage device composition includes a binder, an anti-blocking agent, and a liquid medium,

the content (M1 parts by mass) of the binder and the content (M2 parts by mass) of the anti-blocking agent in the electrical storage device composition satisfying the relationship “1<M1/M2<4,000”.

### Application Example 3

In the electrical storage device composition according to Application Example 2, the anti-blocking agent may be at least one anti-blocking agent selected from the group consisting of a polyethylene wax, a polypropylene wax, a fatty acid amide, a fatty acid ester, and a fatty acid metal salt.

### Application Example 4

In the electrical storage device composition according to Application Example 2 or 3, the binder may be a fluorine-containing binder that includes a repeating unit (Ma) derived from a fluorine-containing ethylene-based monomer, and a repeating unit (Mb) derived from an unsaturated carboxylic ester.

### Application Example 5

In the electrical storage device composition according to Application Example 2 or 3, the binder may be a diene-based binder that includes a repeating unit (Mc) derived from a conjugated diene compound, a repeating unit (Md) derived from an aromatic vinyl compound, a repeating unit (Me) derived from an unsaturated carboxylic ester, and a repeating unit (Mf) derived from an unsaturated carboxylic acid.

### Application Example 6

In the electrical storage device composition according to any one of Application Examples 2 to 5, the hinder may be particles, and the particles may have an average particle size of 50 to 400 nm.

### Application Example 7

According to another aspect of the invention, an electrical storage device slurry includes the electrical storage device composition according to any one of Application Examples 1 to 6, and an active material.

### Application Example 8

According to another aspect of the invention, an electrical storage device electrode includes a collector, and a layer that is formed by applying and drying the electrical storage device slurry according to Application Example 7 on a surface of the collector.

### Application Example 9

According to another aspect of the invention, an electrical storage device electrode includes a protective film that is provided on a surface of the electrical storage device electrode,

the protective film including:

a polymer (A) that includes a repeating unit derived from an unsaturated carboxylic ester; and

a component (B) that is at least one component selected from the group consisting of a polyethylene wax, a polypropylene wax, a fatty acid amide, a fatty acid ester, and a fatty acid metal salt,

the content (M1 parts by mass) of the polymer (A) and the content (M2 parts by mass) of the component (B) in the protective film satisfying the relationship “1<M1/M2<4,000”.

### Application Example 10

According to another aspect of the invention, an electrical storage device electrode includes a protective film that is provided on a surface of the electrical storage device electrode,

the protective film including a binder and an anti-blocking agent,

the content (M1 parts by mass) of the binder and the content (M2 parts by mass) of the anti-blocking agent in the protective film satisfying the relationship “1<M1/M2<4,000”.

### Application Example 11

According to another aspect of the invention, an electrical storage device slurry includes the electrical storage device composition according to any one of Application Examples 1 to 6, and inorganic particles.

### Application Example 12

In the electrical storage device slurry according to Application Example 11, the inorganic particles may be at least one type of particles selected from the group consisting of silica, titanium oxide, aluminum oxide, zirconium oxide, and magnesium oxide.

### Application Example 13

According to another aspect of the invention, an electrical storage device separator includes a layer that is formed by applying and drying the electrical storage device slurry according to Application Example 11 or 12 on a surface of the electrical storage device.

### Application Example 14

According to another aspect of the invention, an electrical storage device separator includes a protective film that is provided on a surface of the electrical storage device separator,

the protective film including:

a polymer (A) that includes a repeating unit derived from an unsaturated carboxylic ester; and

a component (B) that is at least one component selected from the group consisting of a polyethylene wax, a polypropylene wax, a fatty acid amide, a fatty acid ester, and a fatty acid metal salt,

the content (M1 parts by mass) of the polymer (A) and the content (M2 parts by mass) of the component (B) in the protective film satisfying the relationship “1<M1/M2<4,000”.

### Application Example 15

According to another aspect of the invention, an electrical storage device separator includes a protective film that is provided on a surface of the electrical storage device separator,

the protective film including a binder and an anti-blocking agent,

the content (M1 parts by mass) of the binder and the content (M2 parts by mass) of the anti-blocking agent in the protective film satisfying the relationship “1<M1/M2<4,000”.

### Application Example 16

According to another aspect of the invention, an electrical storage device includes the electrical storage device electrode according to any one of Application Examples 8 to 10.

### Application Example 17

According to a further aspect of the invention, an electrical storage device includes the electrical storage device separator according to any one of Application Examples 13 to 15.

### Advantageous Effects of Invention

The electrical storage device compositions according to the aspects of the invention can produce an electrical storage device electrode and an electrical storage device separator that exhibit excellent blocking resistance and can effectively prevent displacement (i.e., achieve moderate blocking) when an electrode and a separator are stacked. The electrical storage device electrodes according to the aspects of the invention exhibit excellent blocking resistance and can effectively prevent displacement (i.e., achieve moderate blocking) when an electrode and a separator are stacked. The electrical storage device separators according to the aspects of the invention exhibit excellent blocking resistance and can effectively prevent displacement (i.e., achieve moderate blocking) when an electrode and a separator are stacked. An electrical storage device that includes an electrical storage device electrode and/or an electrical storage device separator produced using the electrical storage device compositions according to the aspects of the invention exhibits excellent charge-discharge rate characteristics (i.e., electrical characteristics).

### BRIEF DESCRIPTION OF DRAWINGS

FIG. 1 is a cross-sectional view schematically illustrating an electrical storage device electrode according to a first specific example.

FIG. 2 is a cross-sectional view schematically illustrating an electrical storage device electrode according to a second specific example.

FIG. 3 is a cross-sectional view schematically illustrating an electrical storage device separator according to one embodiment of the invention.

### DESCRIPTION OF EMBODIMENTS

Exemplary embodiments of the invention are described in detail below. Note that the invention is not limited to the following exemplary embodiments. It should be understood that the invention includes various modifications that can be practiced without departing from the scope of the invention. The teen “(meth)acrylic acid” used herein includes “acrylic acid” and “methacrylic acid”. The term “(meth)acrylate” used herein includes “acrylate” and “methacrylate”.

### 1. ELECTRICAL STORAGE DEVICE COMPOSITION

An electrical storage device composition according to one embodiment of the invention includes a binder, an anti-blocking agent, and a liquid medium, the content (M1 parts by mass) of the binder and the content (M2 parts by mass) of the anti-blocking agent in the electrical storage device composition satisfying the relationship “1<M1/M2<4,000”.

The electrical storage device composition according to one embodiment of the invention may be used as an electrode binder that is used to form an active material layer on the surface of a collector, and may also be used as a binder that is used to form a protective film on the surface of a separator and/or an electrode. In either case, the content (M1 parts by mass) of the binder and the content (M2 parts by mass) of the anti-blocking agent in the electrical storage device composition satisfy the relationship “1<M1/M2<4,000”. The content (M1 parts by mass) of the binder and the content (M2 parts by mass) of the anti-blocking agent in the electrical storage device composition preferably satisfy the relationship “20<M1/M2<3,000”, and more preferably satisfy the relationship “30<M1/M2<2,500”. When the electrical storage device composition according to one embodiment of the invention is used as an electrode binder, the content (M1 parts by mass) of the binder and the content (M2 parts by mass) of the anti-blocking agent in the electrical storage device composition particularly preferably satisfy the relationship “40<M1/M2<2,000”. When the electrical storage device composition according to one embodiment of the invention is used as a binder that is used to form a protective film on the surface of a separator and/or an electrode, the content (M1 parts by mass) of the binder and the content (M2 parts by mass) of the anti-blocking agent in the electrical storage device composition particularly preferably satisfy the relationship “40<M1/M2<500”. When the content (M1 parts by mass) of the binder and the content (M2 parts by mass) of the anti-blocking agent in the electrical storage device composition satisfy the above relationship, it is possible to provide an electrode and a separator with blocking resistance, and effectively prevent displacement (i.e., achieve moderate blocking) when stacking an electrode and a separator. Therefore, it is possible to prevent a situation in which the charge-discharge characteristics of the electrical storage device deteriorate due to removal of the active material, displacement of the electrode and the separator, and the like. Each component included in the electrical storage device composition according to one embodiment of the invention is described in detail below.

### 1.1. Binder

The binder included in the electrical storage device composition according to one embodiment of the invention binds an active material, and improves adhesion between an active material layer and a collector when used as an electrode binder. The binder included in the electrical storage device composition according to one embodiment of the invention binds inorganic particles, and improves adhesion between the surface of a separator and/or an electrode and a protective film when used as a binder that is used to form a protective film on the surface of a separator and/or an electrode.

The binder is preferably dispersed in the liquid medium in the form of particles (i.e., the electrical storage device composition is preferably a latex). When the electrical storage device composition is a latex, an electrical storage device slurry prepared by mixing the electrical storage device composition with an active material or inorganic particles exhibits good stability and excellent applicability. The binder that is dispersed in the liquid medium in the form of particles is hereinafter referred to as “binder particles”. A commercially available latex may be used as the binder particles.

When the electrical storage device composition according to one embodiment of the invention is used to produce a positive electrode, it is preferable to use a fluorine-containing binder (see below) as the binder due to excellent oxidation resistance and excellent adhesion. When the electrical storage device composition according to one embodiment of the invention is used to produce a negative electrode, it is preferable to use a diene-based binder (see below) as the binder. The binder included in the electrical storage device composition according to one embodiment of the invention may include at least one polymer selected from the group consisting of a polyamic acid and an imidized polymer thereof

### 1.1.1. Fluorine-Containing Binder

When the electrical storage device composition according to one embodiment of the invention is used to produce a positive electrode, it is preferable use a fluorine-containing binder that includes a repeating unit (Ma) derived from a fluorine-containing ethylene-based monomer and a repeating unit (Mb) derived from an unsaturated carboxylic ester as the binder.

### 1.1.1.1. Repeating Unit (Ma) Derived from Fluorine-Containing Ethylene-Based Monomer

Examples of the fluorine-containing ethylene-based monomer include a fluorine-containing olefin compound, a fluorine-containing (meth)acrylate compound, and the like. Examples of the fluorine-containing olefin compound include vinylidene fluoride, tetrafluoroethylene, hexafluoropropylene, ethylene chloride trifluoride, a perfluoroalkyl vinyl ether, and the like. Examples of the fluorine-containing (meth)acrylate compound include a compound represented by the following general formula (1), [4[1-trifluoromethyl-2,2-bis[bis(trifluoromethyl)fluoromethyl]ethynyloxy]benzoxy]2-hydroxypropyl(meth)acrylate, and the like.

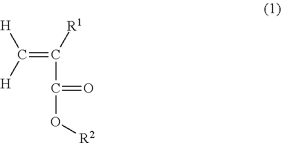

wherein R¹ is a hydrogen atom or a methyl group, and R² is a fluorine-containing hydrocarbon group having 1 to 18 carbon atoms.

Examples of the fluorine-containing hydrocarbon group having 1 to 18 carbon atoms represented by R² in the general formula (1) include a fluoroalkyl group having 1 to 12 carbon atoms, a fluoroaryl group having 6 to 16 carbon atoms, a fluoroaralkyl group having 7 to 18 carbon atoms, and the like. R² is preferably a fluoroalkyl group having 1 to 12 carbon atoms. Specific examples of a preferable fluorine-containing hydrocarbon group having 1 to 18 carbon atoms represented by R² in the general formula (1) include a 2,2,2-trifluoroethyl group, a 2,2,3,3,3-pentafluoropropyl group, a 1,1,1,3,3,3-hexafluoropropan-2-yl group, a beta-(perfluorooctyl)ethyl group, a 2,2,3,3-tetrafluoropropyl group, a 2,2,3,4,4,4-hexafluorobutyl group, a 1h,1h,5h-octafluoropentyl group, a 1h,1h,9h-perfluoro-1-nonyl group, a 1h,1h,11h-perfluoroundecyl group, a perfluorooctyl group, and the like.

The fluorine-containing ethylene-based monomer is preferably a fluorine-containing olefin compound, and more preferably at least one compound selected from the group consisting of vinylidene fluoride, tetrafluoroethylene, and hexafluoropropylene. These fluorine-containing ethylene-based monomers may be used either alone or in combination.

The content of the repeating unit (Ma) derived from a fluorine-containing ethylene-based monomer in the fluorine-containing binder is preferably 20 to 40 parts by mass, and more preferably 25 to 35 parts by mass, based on 100 parts by mass of the total repeating units.

### 1.1.1.2. Repeating Unit (Mb) Derived from Unsaturated Carboxylic Ester

A polymer that includes a repeating unit derived from an unsaturated carboxylic ester has not been used to produce a positive electrode since such a polymer has been considered to exhibit poor oxidation resistance in spite of excellent adhesion. It was found that sufficient oxidation resistance can be obtained while maintaining excellent adhesion by utilizing a fluorine-containing binder that includes the repeating unit (Ma) derived from a fluorine-containing ethylene-based monomer and the repeating unit (Mb) derived from an unsaturated carboxylic ester. Such a fluorine-containing binder can suitably be used to produce a positive electrode.

The unsaturated carboxylic ester is preferably a (meth)acrylate compound. Specific examples of the (meth)acrylate compound include methyl (meth)acrylate, ethyl (meth)acrylate, n-propyl (meth)acrylate, i-propyl (meth)acrylate, n-butyl (meth)acrylate, i-butyl (meth)acrylate, n-amyl (meth)acrylate, i-amyl (meth)acrylate, hexyl (meth)acrylate, cyclohexyl (meth)acrylate, 2-ethylhexyl (meth)acrylate, n-octyl (meth)acrylate, nonyl (meth)acrylate, decyl (meth)acrylate, hydroxymethyl (meth)acrylate, hydroxyethyl (meth)acrylate, ethylene glycol (meth)acrylate, ethylene glycol di(meth)acrylate, propylene glycol di(meth)acrylate, trimethylolpropane tri(meth)acrylate, pentaerythritol tetra(meth)acrylate, dipentaerythritol hexa(meth)acrylate, allyl (meth)acrylate, ethylene di(meth)acrylate, and the like. The (meth)acrylate compound may be one or more compounds selected from these compounds. It is preferable to use one or more (meth)acrylate compounds selected from methyl (meth)acrylate, ethyl (meth)acrylate, and 2-ethylhexyl (meth)acrylate. It is particularly preferable to use methyl (meth)acrylate.

The content of the repeating unit (Mb) derived from an unsaturated carboxylic ester in the fluorine-containing binder is preferably 45 to 80 parts by mass, and more preferably 50 to 70 parts by mass, based on 100 parts by mass of the total repeating units.

### 1.1.1.3. Additional Repeating Unit

The fluorine-containing binder may further include a repeating unit derived from an alpha,beta-unsaturated nitrile compound, a repeating unit derived from an unsaturated carboxylic acid, a repeating unit derived from a conjugated diene compound, a repeating unit derived from an aromatic vinyl compound, and a repeating unit derived from an unsaturated monomer other than these compounds.

### 1.1.1.4. Method for Synthesizing Fluorine-Containing Binder

The fluorine-containing binder may be synthesized using an arbitrary method. For example, the fluorine-containing binder may be synthesized using the method disclosed in Japanese Patent No. 4849286.

### 1.1.2. Diene-Based Binder

When the electrical storage device composition according to one embodiment of the invention is used to produce a negative electrode, it is preferable to use a diene-based hinder as the binder. The diene-based binder preferably includes a repeating unit (Mc) derived from a conjugated diene compound, a repeating unit (Md) derived from an aromatic vinyl compound, a repeating unit (Me) derived from an unsaturated carboxylic ester, and a repeating unit (Mf) derived from an unsaturated carboxylic acid.

### 1.1.2.1. Repeating Unit (Mc) Derived from Conjugated Diene Compound

When the diene-based binder includes the repeating unit (Mc) derived from a conjugated diene compound, a negative electrode binder that exhibits excellent viscoelasticity and strength can easily be produced. Specifically, a polymer that includes a repeating unit derived from a conjugated diene compound exhibits a high binding capability. Since the rubber elasticity due to the conjugated diene compound is provided to the polymer, the polymer can follow a change in volume of an electrode. The polymer thus exhibits an improved binding/bonding capability, and also exhibits durability that maintains the charge-discharge characteristics for a long time.

Examples of the conjugated diene compound include 1,3-butadiene, 2-methyl-1,3-butadiene, 2,3-dimethyl-1,3-butadiene, 2-chloro-1,3-butadiene, and the like. The conjugated diene compound may be one or more compounds selected from these compounds. It is particularly preferable to use 1,3-butadiene as the conjugated diene compound.

The content of the repeating unit (Mc) derived from a conjugated diene compound in the diene-based binder is preferably 30 to 60 parts by mass, and more preferably 40 to 55 parts by mass, based on 100 parts by mass of the total repeating units. When the content of the repeating unit (Mc) is within the above range, the binding capability is further improved.

### 1.1.2.2. Repeating Unit (Md) Derived from Aromatic Vinyl Compound

When the diene-based binder includes the repeating unit (Md) derived from an aromatic vinyl compound, the diene-based binder exhibits excellent affinity to a conductivity-imparting agent included in a negative electrode slurry.

Specific examples of the aromatic vinyl compound include styrene, alpha-methylstyrene, p-methylstyrene, vinyltoluene, chloro styrene, divinylbenzene, and the like. The aromatic vinyl compound may be one or more compounds selected from these compounds. It is particularly preferable to use styrene as the aromatic vinyl compound.

The content of the repeating unit (Md) derived from an aromatic vinyl compound in the diene-based binder is preferably 10 to 40 parts by mass, and more preferably 15 to 35 parts by mass, based on 100 parts by mass of the total repeating units. When the content of the repeating unit (Md) is within the above range, the binder exhibits a moderate binding/bonding capability with respect to graphite that may be used as an active material. Moreover, the resulting active material layer exhibits excellent flexibility and good adhesion to a collector.

### 1.1.2.3. Repeating Unit (Me) Derived from Unsaturated Carboxylic Ester

When the diene-based binder includes the repeating unit (Me) derived from an unsaturated carboxylic ester, the diene-based binder exhibits good affinity to an electrolyte solution. This makes it possible to suppress an increase in internal resistance that may occur when the binder serves as an electrical resistance component in the electrical storage device. It is also possible to prevent a decrease in binding/bonding capability due to excessive absorption of the electrolyte solution.

A (meth)acrylate compound is preferable as the unsaturated carboxylic ester. Examples of the (meth)acrylate compound include the compounds mentioned above (see “1.1.1.2. Repeating unit (Mb) derived from unsaturated carboxylic ester”).

The content of the repeating unit (Me) derived from an unsaturated carboxylic ester in the diene-based binder is preferably 5 to 40 parts by mass, and more preferably 10 to 30 parts by mass, based on 100 parts by mass of the total repeating units. When the content of the repeating (Me) is within the above range, the diene-based binder exhibits moderate affinity to an electrolyte solution. This makes it possible to suppress an increase in internal resistance that may occur when the binder serves as an electrical resistance component in the electrical storage device. It is also possible to prevent a decrease in binding/bonding capability due to excessive absorption of the electrolyte.

### 1.1.2.4. Repeating Unit (Mf) Derived from Unsaturated Carboxylic Acid

When the diene-based binder includes the repeating unit (Mf) derived from an unsaturated carboxylic acid, it is possible to improve the stability of an electrical storage device slurry that is prepared using the electrical storage device composition according to one embodiment of the invention.

Specific examples of the unsaturated carboxylic acid include a mono- or dicarboxylic acid such as acrylic acid, methacrylic acid, crotonic acid, maleic acid, fumaric acid, and itaconic acid. The unsaturated carboxylic acid may be one or more compounds selected from these compounds. It is preferable to use one or more compounds selected from acrylic acid, methacrylic acid, and itaconic acid.

The content of the repeating unit (Mf) derived from an unsaturated carboxylic acid in the diene-based binder is preferably 15 parts by mass or less, and more preferably 0.3 to 10 parts by mass, based on 100 parts by mass of the total repeating units. When the content of the repeating unit (Mf) is within the above range, the diene-based binder exhibits excellent dispersion stability (i.e., aggregates are rarely formed) when preparing an electrical storage device slurry. Moreover, an increase in viscosity of the slurry with the passing of time can be suppressed.

### 1.1.2.5. Additional Repeating Unit

The diene-based binder may include an additional repeating unit other than the above repeating units. Examples of the additional repeating unit include a repeating unit derived from an alpha,beta-unsaturated nitrile compound.

Specific examples of the alpha,beta-unsaturated nitrile compound include acrylonitrile, methacrylonitrile, alpha-chloroacrylonitrile, alpha-ethylacrylonitrile, vinylidene cyanide, and the like. The alpha,beta-unsaturated nitrile compound may be one or more compounds selected from these compounds. It is preferable to use one or more compounds selected from acrylonitrile and methacrylonitrile. It is more preferable to use acrylonitrile.

The content of the repeating unit derived from an alpha,beta-unsaturated nitrile compound in the diene-based binder is preferably 35 parts by mass or less, and more preferably 10 to 25 parts by mass, based on 100 parts by mass of the total repeating units. When the content of the repeating unit derived from an alpha,beta-unsaturated nitrile compound is within the above range, the diene-based binder exhibits excellent affinity to an electrolyte solution, and has a moderate swelling ratio. This contributes to an improvement in battery characteristics.

The diene-based binder may further include repeating units derived from a fluorine-containing compound that includes an ethylenically unsaturated bond, such as vinylidene fluoride, tetrafluoroethylene, and hexafluoropropylene; an alkylamide of an ethylenically unsaturated carboxylic acid, such as (meth)acrylamide and N-methylolacrylamide; a vinyl carboxylate such as vinyl acetate and vinyl propionate; an ethylenically unsaturated dicarboxylic anhydride; a monoalkyl ester; a monoamide; an aminoalkylamide of an ethylenically unsaturated carboxylic acid, such as aminoethylacrylamide, dimethylaminomethylmethacrylamide, and methylaminopropylmethacrylamide; and the like.

### 1.1.2.6. Method for Synthesizing Diene-Based Binder

The diene-based binder may be synthesized using an arbitrary method. For example, the diene-based binder may be synthesized using the method disclosed in Japanese Patent No. 5146710.

### 1.1.3. Polyamic Acid and Imidized Polymer Thereof

The binder included in the electrical storage device composition according to one embodiment of the invention may include at least one polymer selected from the group consisting of a polyamic acid and an imidized polymer thereof. The polyamic acid may be obtained by reacting a tetracarboxylic dianhydride with a diamine. A partial imidized product of the polyamic acid may be obtained by subjecting part of the amic acid structure of the polyamic acid to a dehydration/ring-closing reaction to effect imidization.

Examples of the tetracarboxylic dianhydride and the diamine used to synthesize the polyamic acid include those disclosed in JP-A-2010-97188. The polyamic acid and the imidized polymer thereof may be synthesized using the method disclosed in Japanese Patent No. 5099394.

### 1.1.4. Average Particle Size of Binder Particles

When the fluorine-containing binder or the diene-based binder is the binder particles, the average particle size of the binder particles is preferably 50 to 400 nm, and more preferably 100 to 250 nm. When the average particle size of the binder particles is within the above range, the binder particles are effectively adsorbed on the surface of the active material or the inorganic particles, and it is possible to advantageously bind the active material or the inorganic particles. Moreover, since the binder particles can follow the movement of the active material, it is possible to suppress migration of the binder particles or the active material particles, and prevent deterioration in electrical characteristics of the electrode. The average particle size of the binder particles may be measured by the method disclosed in Japanese Patent No. 5146710 in accordance with JIS Z 8826 using a particle size distribution analyzer that utilizes a dynamic light scattering method as the measurement principle.

### 1.2. Anti-Blocking Agent

An active material layer that includes an anti-blocking agent can be formed on the surface of a collector by applying an electrical storage device slurry that includes the electrical storage device composition according to one embodiment of the invention to the surface of a collector, and drying the applied electrical storage device slurry. A protective film that includes an anti-blocking agent can be formed on the surface of an active material layer or a separator by applying an electrical storage device slurry that includes the electrical storage device composition according to one embodiment of the invention to the surface of an active material layer or a separator, and drying the applied electrical storage device slurry. It is considered that the anti-blocking agent bleeds out from the surface of the active material layer or the protective film that includes the anti-blocking agent to provide the electrode or the separator with blocking resistance.

The anti-blocking agent included in the electrical storage device composition according to one embodiment of the invention may be dissolved in the liquid medium, or may be dispersed in the liquid medium in the form of droplet particles. When the anti-blocking agent is dispersed in the liquid medium in the form of droplet particles, the average particle size of the droplet particles is preferably 1 to 100 micrometers, and more preferably 5 to 50 micrometers. When the average particle size of the droplet particles is within the above range, the droplet particles easily bleed out from the surface of the active material layer of the electrode or the surface of the protective film of the separator to provide the electrode or the separator with blocking resistance. The average particle size of the droplet particles may be measured using a particle size distribution analyzer that utilizes a laser diffraction-scattering method (Microtrac method) as a measurement principle. Examples of such a particle size distribution analyzer include Microtrac MT3000II (manufactured by Nikkiso Co., Ltd.), and the like.

Examples of the anti-blocking agent include a synthetic hydrocarbon-based wax such as a fluorine-based polymer, a polyethylene wax, a polypropylene wax, an ethylene-propylene copolymer wax, a Fischer-Tropsch wax, a partial oxide thereof, and a copolymer thereof with an ethylenically unsaturated carboxylic acid; a modified wax such as a montan wax derivative, a paraffin wax derivative, and a microcrystalline wax derivative; a hydrogenated wax such as a hardened castor oil and a hardened castor oil derivative; a higher fatty acid and an alcohol such as cetyl alcohol, stearic acid, and 12-hydroxystearic acid; a fatty acid ester such as glyceryl stearate, polyethylene glycol stearate, stearyl stearate, and isopropyl palmitate; a fatty acid amide such as stearic acid amide; a fatty acid metal salt such as calcium stearate and lithium stearate; a phthalic anhydride imide; a chlorinated hydrocarbon; and the like.

Among these, a synthetic hydrocarbon-based wax such as a polyethylene wax, a polypropylene wax, an ethylene-propylene copolymer wax, a Fischer-Tropsch wax, a partial oxide thereof; and a copolymer thereof with an ethylenically unsaturated carboxylic acid, a modified wax such as a montan wax derivative, a paraffin wax derivative, and a microcrystalline wax derivative, a higher fatty acid and an alcohol such as cetyl alcohol, stearic acid, and 12-hydroxystearic acid, a fatty acid amide such as stearic acid amide, and a fatty acid metal salt are preferable. A synthetic hydrocarbon-based wax such as a polyethylene wax, a polypropylene wax, an ethylene-propylene copolymer wax, a Fischer-Tropsch wax, a partial oxide thereof; and a copolymer thereof with an ethylenically unsaturated carboxylic acid, a higher fatty acid and an alcohol such as cetyl alcohol, stearic acid, and 12-hydroxystearic acid, a fatty acid amide such as stearic acid amide, and a fatty acid metal salt such as calcium stearate and lithium stearate are more preferable.

When the anti-blocking agent is dispersed in the liquid medium in the form of droplet particles, a container is charged with the anti-blocking agent, the liquid medium, and a dispersant, and the mixture is heated with stirring, and cooled, for example.

The content of the anti-blocking agent in the electrical storage device composition according to one embodiment of the invention is preferably 0.01 to 5 mass %, more preferably 0.015 to 3 mass %, and particularly preferably 0.02 to 1 mass %. When the content of the anti-blocking agent is within the above range, it is possible to provide the electrode or the separator with blocking resistance without impairing the stability of the electrical storage device composition.

### 1.3. Liquid Medium

The electrical storage device composition according to one embodiment of the invention includes the liquid medium. An aqueous medium that includes water is preferable as the liquid medium. The aqueous medium may include a non-aqueous medium other than water. Examples of the non-aqueous medium include an amide compound, a hydrocarbon, an alcohol, a ketone, an ester, an amine compound, a lactone, a sulfoxide, a sulfone compound, and the like. The non-aqueous medium may be one or more compounds selected from these compounds. When the liquid medium is an aqueous medium, the content of water in the liquid medium is preferably 90 mass % or more, and more preferably 98 mass % or more, based on the total amount (100 mass %) of the liquid medium. When an aqueous medium is used as the liquid medium, the electrical storage device composition according to one embodiment of the invention has a low impact on the environment, and is highly safe for the operator.

The content of the non-aqueous medium in the aqueous medium is preferably 10 parts by mass or less, and more preferably 5 parts by mass or less, based on 100 parts by mass of the aqueous medium. It is particularly preferable that the aqueous medium substantially does not include a non-aqueous medium. The expression “substantially does not include” used herein in connection with the non-aqueous medium means that the non-aqueous medium is not intentionally added as the liquid medium. Specifically, the liquid medium may include a non-aqueous medium that is inevitably mixed in the liquid medium when preparing the electrical storage device composition.

### 1.4. Additive

The electrical storage device composition according to one embodiment of the invention may optionally include an additive other than the above components. Examples of the additive include a thickener. When the electrical storage device composition according to one embodiment of the invention includes a thickener, it is possible to further improve the applicability of the electrical storage device composition, the charge-discharge characteristics of the resulting electrical storage device, and the like.

Examples of the thickener include a cellulose compound such as carboxymethyl cellulose, methyl cellulose, and hydroxypropyl cellulose; an ammonium salt or an alkali metal salt of the cellulose compound; a polycarboxylic acid such as poly(meth)acrylic acid and a modified poly(meth)acrylic acid; an alkali metal salt of the polycarboxylic acid; a polyvinyl alcohol-based (co)polymer such as polyvinyl alcohol, a modified polyvinyl alcohol, and an ethylene/vinyl alcohol copolymer; a water-soluble polymer such as a saponified product of a copolymer of a vinyl ester and an unsaturated carboxylic acid (e.g., (meth)acrylic acid, maleic acid, or fumaric acid); and the like. It is particularly preferable to use an alkali metal salt of carboxymethyl cellulose, an alkali metal salt of poly(meth)acrylic acid, or the like as the thickener.

Examples of commercially available products of these thickeners include CMC1120, CMC1150, CMC2200, CMC2280, CMC2450 (an alkali metal salt of carboxymethyl cellulose) (manufactured by Daicel Corporation); and the like.

When the electrical storage device composition according to one embodiment of the invention includes the thickener, the content of the thickener in the electrical storage device composition is preferably 5 mass % or less, and more preferably 0.1 to 3 mass %, based on the total solid content in the electrical storage device composition.

### 2. ELECTRICAL STORAGE DEVICE SLURRY

An electrical storage device slurry according to one embodiment of the invention may be prepared using the electrical storage device composition according to one embodiment of the invention. The electrical storage device slurry according to one embodiment of the invention may be roughly classified into an electrical storage device electrode slurry and a protective film-forming slurry.

### 2.1. Electrical Storage Device Electrode Slurry

The term “electrical storage device electrode slurry” used herein refers to a dispersion that is applied to the surface of a collector, and dried to form an active material layer on the surface of the collector. An electrical storage device electrode slurry according to one embodiment of the invention includes the electrical storage device composition and an active material. Each component included in the electrical storage device electrode slurry according to one embodiment of the invention is described in detail below. Note that the components of the electrical storage device composition are the same as described above, and description thereof is omitted.

### 2.1.1. Active Material

A material for forming the active material included in the electrical storage device electrode slurry according to one embodiment of the invention is not particularly limited. An appropriate material may be selected taking account of the type of the target electrical storage device. Examples of the active material include a carbon material, a silicon material, an oxide that includes a lithium atom, a lead compound, a tin compound, an arsenic compound, an antimony compound, an aluminum compound, and the like.

Examples of the carbon material include amorphous carbon, graphite, natural graphite, mesocarbon microbeads (MCMB), pitch-based carbon fibers, and the like.

Examples of the silicon material include silicon, a silicon oxide, a silicon alloy, silicon oxide complexes represented by SiC, SiOₓC_{y} (0<x≦3, 0<y≦5), Si₃N₄, Si₂N₂O, and SiOₓ (0<x≦2) (e.g., the materials disclosed in JP-A-2004-185810 and JP-A-2005-259697), and the silicon materials disclosed in JP-A-2004-185810. A silicon oxide represented by SiOₓ (0<x<2, and preferably 0.1≦x≦1) is preferable as the silicon oxide. An alloy of silicon and at least one transition metal selected from the group consisting of titanium, zirconium, nickel, copper, iron, and molybdenum is preferable as the silicon alloy. Alloys of silicon and these transition metals have high electron conductivity, and exhibit high strength. When the active material includes these transition metals, the transition metals present on the surface of the active material are oxidized to form an oxide having a surface hydroxyl group, and the binding capability with the binder is further improved. It is preferable to use a silicon-nickel alloy or a silicon-titanium alloy as the silicon alloy. It is particularly preferable to use a silicon-titanium alloy as the silicon alloy. The silicon content in the silicon alloy is preferably 10 mol % or more, and more preferably 20 to 70 mol %, based on the total metal elements included in the silicon alloy. Note that the silicon material may be single crystalline, polycrystalline, or amorphous.

When using the silicon material as the active material, an active material other than the silicon material may be used in combination with the silicon material. Examples of the active material other than the silicon material include a conductive polymer such as polyacene; a complex metal oxide represented by A_{X}B_{Y}O_{Z} (wherein A is an alkali metal or a transition metal, B is at least one metal selected from transition metals such as cobalt, nickel, aluminum, tin, and manganese, O is an oxygen atom, and X, Y, and Z are numbers that satisfy 1.10>X>0.05, 4.00>Y>0.85, and 5.00>Z>1.5); other metal oxides; and the like. It is preferable to use a carbon material in combination with the silicon material since a change in volume due to occlusion and release of lithium is small.

Examples of the oxide that includes a lithium atom include lithium cobaltate, lithium nickelate, lithium manganate, lithium nickel cobalt manganate, LiFePO₄, LiCoPO₄, LiMnPO₄, Li_{0.90}Ti_{0.05}Nb_{0.05}Fe_{0.30}Co_{0.30}Mn_{0.30}PO₄, and the like.

It is preferable that the active material have a particulate shape. The average particle size of the active material is preferably 0.1 to 100 micrometers, and more preferably 1 to 20 micrometers.

The active material is preferably used in such an amount that the content of the binder is 0.1 to 25 parts by mass, and more preferably 0.5 to 15 parts by mass, based on 100 parts by mass of the active material. When the active material is used in an amount within the above range, it is possible to produce an electrode that exhibits better adhesion, has low resistance, and exhibits better charge-discharge characteristics.

### 2.1.2. Additional Component

The electrical storage device electrode slurry may optionally include an additional component other than the above components. Examples of the additional component include a conductivity-imparting agent, a non-aqueous medium, a thickener, and the like.

### 2.1.2.1. Conductivity-Imparting Agent

A lithium-ion secondary battery may include carbon or the like as the conductivity-imparting agent. A nickel-hydrogen secondary battery may include cobalt oxide as the conductivity-imparting agent included in the positive electrode, and may include a nickel powder, cobalt oxide, titanium oxide, carbon, or the like as the conductivity-imparting agent included in the negative electrode. Examples of the carbon include graphite, activated carbon, acetylene black, furnace black, graphite, carbon fibers, fullerenes, and the like. Among these, acetylene black or furnace black is preferable. The conductivity-imparting agent is preferably used in an amount of 20 parts by mass or less, more preferably 1 to 15 parts by mass, and particularly preferably 2 to 10 parts by mass, based on 100 parts by mass of the active material.

### 2.1.2.2. Non-Aqueous Medium

The electrical storage device electrode slurry may include a non-aqueous medium that has a normal boiling point of 80 to 350° C. from the viewpoint of improving the applicability of the electrical storage device electrode slurry. Specific examples of the non-aqueous medium include an amide compound such as N-methylpyrrolidone, dimethylformamide, and N,N-dimethylacetamide; a hydrocarbon such as toluene, xylene, n-dodecane, and tetralin; an alcohol such as 2-ethyl-1-hexanol, 1-nonanol, and lauryl alcohol; a ketone such as methyl ethyl ketone, cyclohexanone, phorone, acetophenone, and isophorone; an ester such as benzyl acetate, isopentyl butyrate, methyl lactate, ethyl lactate, and butyl lactate; an amine compound such as o-toluidine, m-toluidine, and p-toluidine; a lactone such as gamma-butyrolactone and delta-butyrolactone; a sulfoxide/sulfone compound such as dimethyl sulfoxide and sulfolane; and the like. The non-aqueous medium may be one or more compounds selected from these compounds. It is preferable to use N-methylpyrrolidone as the non-aqueous medium in terms of the stability of the binder particles, workability when applying the electrical storage device electrode slurry, and the like.

### 2.1.2.3. Thickener

The electrical storage device electrode slurry may include a thickener in order to improve the applicability of the electrical storage device electrode slurry. Specific examples of the thickener include the compounds mentioned above see “1.4. Additive”).

When the electrical storage device electrode slurry includes a thickener, the thickener is preferably used in a ratio of 20 mass % or less, more preferably 0.1 to 15 mass %, and particularly preferably 0.5 to 10 mass %, based on the total solid content in the electrical storage device electrode slurry.

### 2.1.3. Method for Producing Electrical Storage Device Electrode Slurry

The electrical storage device electrode slurry according to one embodiment of the invention may be produced by mixing the electrical storage device composition, the active material, water, and an optional additive. The components may be mixed with stirring using a known method (e.g., a method that utilizes a stirrer, a deaerator, a bead mill, a high-pressure homogenizer, or the like).

When producing the electrical storage device electrode slurry by mixing (stirring) the components, it is necessary to select a mixer that can stir the components so that aggregates of the active material do not remain in the resulting slurry, and select necessary and sufficient dispersion conditions. The degree of dispersion can be measured using a grind gauge. It is preferable to mix and disperse the components so that the resulting slurry does not include aggregates having a size larger than 100 micrometers. Examples of the mixer that satisfies the above conditions include a ball mill, a sand mill, a pigment disperser, a grinder, an ultrasonic disperser, a homogenizer, a planetary mixer, a Hobart mixer, and the like.

### 2.2. Protective Film-Forming Slurry

The term “protective film-forming slurry” used herein refers to a dispersion that is applied to the surface of either or both of an electrode and a separator, and dried to form a protective film on the surface of either or both of the electrode and the separator. A protective film-forming slurry according to one embodiment of the invention includes the electrical storage device composition and inorganic particles. Each component included in the protective film-forming slurry according to one embodiment of the invention is described in detail below. Note that the components of the electrical storage device composition are the same as described above, and description thereof is omitted.

### 2.2.1. Inorganic Particles

The inorganic particles included in the protective film-forming slurry according to one embodiment of the invention improve the toughness of the resulting protective film. Examples of the inorganic particles include silica, titanium oxide (titania), aluminum oxide (alumina), zirconium oxide (zirconia), magnesium oxide (magnesia), and the like. Among these, titanium oxide and aluminum oxide are preferable from the viewpoint of improving the toughness of the protective film. It is preferable to use rutile-type titanium oxide as the titanium oxide.

The average particle size of the inorganic particles is preferably 1 micrometer or less, and more preferably 0.1 to 0.8 micrometers. Note that it is preferable that the average particle size of the inorganic particles be larger than the average pore size of the separator (porous membrane). This makes it possible to reduce damage applied to the separator, and prevent a situation in which the pores of the separator are clogged by the inorganic particles.

The content (on a solid basis) of the electrical storage device composition in the protective film-forming slurry according to one embodiment of the invention is preferably 0.1 to 20 parts by mass, and more preferably 1 to 10 parts by mass, based on 100 parts by mass of the inorganic particles. When the content (on a solid basis) of the electrical storage device composition in the protective film-forming slurry is within the above range, the resulting protective film exhibits toughness and lithium ion permeability in a well-balanced manner, and the resistance increase ratio of the resulting electrical storage device can be reduced.

### 2.2.2. Additional Component

The protective film-forming slurry according to one embodiment of the invention may optionally include an additional component such as those described above in connection with the electrical storage device electrode slurry in the amounts described above in connection with the electrical storage device electrode slurry (see “2.1.2. Additional component”).

### 2.2.3. Method for Producing Protective Film-Forming Slurry

The protective film-forming slurry according to one embodiment of the invention is prepared by mixing the electrical storage device composition, the inorganic particles, and an optional additional component. Examples of the mixing means include a known mixer such as a ball mill, a sand mill, a pigment disperser, a grinder, an ultrasonic disperser, a homogenizer, a planetary mixer, and a Hobart mixer.

When producing the protective film-forming slurry according to one embodiment of the invention by mixing (stirring) the components, it is necessary to select a mixer that can stir the components so that aggregates of the inorganic particles do not remain in the resulting slurry, and select necessary and sufficient dispersion conditions. The degree of dispersion can be measured using a grind gauge. It is preferable to mix and disperse the components so that the resulting slurry does not include aggregates having a size larger than 100 micrometers. Examples of the mixer that satisfies the above conditions include a ball mill, a sand mill, a pigment disperser, a grinder, an ultrasonic disperser, a homogenizer, a planetary mixer, a Hobart mixer, and the like.

### 3. ELECTRICAL STORAGE DEVICE ELECTRODE

An electrical storage device electrode according to one embodiment of the invention includes a protective film that is provided on the surface thereof, the protective film including a binder and an anti-blocking agent, the content (M1 parts by mass) of the binder and the content (M2 parts by mass) of the anti-blocking agent in the protective film satisfying the relationship “1<M1/M2<4,000”. The term “protective film” used herein refers to a film or a layer that is situated on the outermost surface of an electrical storage device electrode or an electrical storage device separator, and includes a binder and an anti-blocking agent. The binder, the anti-blocking agent, and the relationship between the content of the binder and the content of the anti-blocking agent are the same as described above in connection with the electrical storage device composition, and description thereof is omitted. Note that the electrical storage device electrode composition according to one embodiment of the invention can be used as both a positive electrode and a negative electrode. Specific examples of the electrical storage device electrode according to one embodiment of the invention are described below with reference to the drawings.

### 3.1 First Specific Example

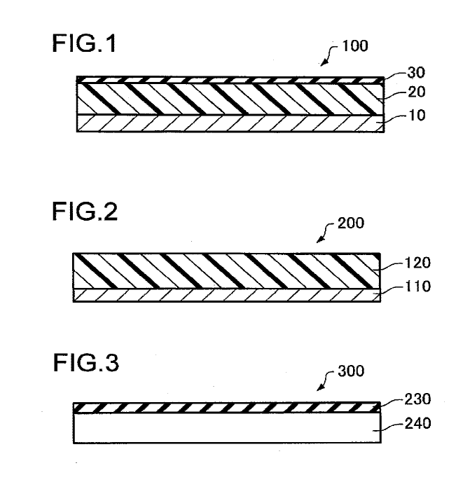

FIG. 1 is a cross-sectional view schematically illustrating an electrical storage device electrode according to a first specific example. As illustrated in FIG. 1, an electrical storage device electrode 100 includes a collector 10, an active material layer 20 that is formed on the surface of the collector 10, and a protective film 30 that is formed on the surface of the active material layer 20. Although the electrical storage device electrode 100 illustrated in FIG. 1 has a configuration in which the active material layer 20 and the protective film 30 are formed on only one side of the collector 10 that extends along the longitudinal direction, the active material layer 20 and the protective film 30 may be formed on each side of the collector 10. When producing an electrical storage device, an electrode and a separator are positioned and stacked to obtain a laminate, and the laminate is formed (e.g., wound) (see above). Therefore, when the electrical storage device electrode 100 has a configuration in which the protective film 30 is formed on at least the surface that comes in contact with the separator, the electrical storage device electrode 100 exhibits blocking resistance, and it is possible to prevent a situation in which removal (fall) of the active material and the like occurs due to forming.

The collector 10 is not particularly limited as long as the collector 10 is formed of a conductive material. A collector formed of a metal (e.g., iron, copper, aluminum, nickel, or stainless steel) is used for a lithium-ion secondary battery. It is preferable to use an aluminum collector for the positive electrode, and use a copper collector for the negative electrode. A collector formed of a perforated metal, an expanded metal, wire gauze, a foam metal, sintered metal fibers, a metal-plated resin sheet, or the like is used for a nickel-hydrogen secondary battery. The shape and the thickness of the collector are not particularly limited. It is preferable to use a sheet-like collector having a thickness of about 0.001 to about 0.5 mm.

The active material layer 20 is a layer that is formed by applying a slurry that includes a binder and an active material to the surface of the collector 10, and drying the applied slurry. The thickness of the active material layer 20 is not particularly limited, but is normally 0.005 to 5 mm, and preferably 0.01 to 2 mm. When the thickness of the active material layer is within the above range, the electrolyte solution can be effectively absorbed in the active material layer. As a result, metal ions are easily transferred between the active material included in the active material layer and the electrolyte solution due to charge and discharge, and the resistance of the electrode can be further reduced. Moreover, since the active material layer is not removed from the collector even if the electrode is folded or wound, an electrical storage device electrode that exhibits excellent adhesion and excellent flexibility can be obtained.

The slurry may be applied to the collector 10 using an arbitrary method. For example, the slurry may be applied to the collector 10 using a doctor blade method, a dipping method, a reverse roll method, a direct roll method, a gravure method, an extrusion method, an immersion method, a brush coating method, or the like. The amount of the electrical storage device electrode slurry applied to the collector 10 is not particularly limited. It is preferable to apply the slurry to the collector 10 so that an active material layer obtained by removing the liquid medium (water and an optional non-aqueous medium) has a thickness of 0.005 to 5 mm, and more preferably 0.01 to 2 mm.

The film formed by applying the slurry may be dried (i.e., water and an optional non-aqueous medium may be removed) using an arbitrary method. For example, the film may be dried using warm air, hot air, or low humid air, or may be dried under vacuum, or may be dried by applying (far) infrared radiation, electron beams, or the like. The drying speed may be appropriately set so that the liquid medium can be removed as quickly as possible while preventing a situation in which cracks occur in the active material layer due to stress concentration, or the active material layer is removed from the collector. The film is preferably dried at 20 to 250° C. (more preferably 50 to 150° C.) for 1 to 120 minutes (more preferably 5 to 60 minutes).

It is preferable to increase the density of the active material layer by pressing the dried active material layer so that the porosity falls within the following range. The collector may be pressed using a die press, a roll press, or the like. The press conditions are appropriately set depending on the type of press, and the desired porosity and density of the active material layer. The press conditions can be easily set by a person having ordinary skill in the art by performing some preliminary experiments. When using a roll press, the linear pressure of the roll press may be set to 0.1 to 10 t/cm, and preferably 0.5 to 5 t/cm, the roll temperature may be set to 20 to 100° C., and the feed speed (roll rotational speed) of the dried collector may be set to 1 to 80 m/min, and preferably 5 to 50 m/min.

The density of the active material layer after pressing is preferably 1.5 to 5.0 g/cm³, more preferably 1.5 to 4.0 g/cm³, and particularly preferably 1.6 to 3.8 g/cm³.

The protective film 30 is a layer that is formed by applying the protective film-forming slurry (see above) to the surface of the active material layer 20, and drying the applied protective film-forming slurry. Since the protective film-forming slurry includes the anti-blocking agent, the protective film 30 includes at least the anti-blocking agent.

The protective film-forming slurry may be applied to the active material layer 20 using an arbitrary method. For example, the protective film-forming slurry may be applied to the active material layer 20 using a doctor blade method, a dipping method, a reverse roll method, a direct roll method, a gravure method, an extrusion method, an immersion method, a brush coating method, or the like. The resulting film is preferably dried at 20 to 250° C. (more preferably 50 to 150° C.) for 1 to 120 minutes (more preferably 5 to 60 minutes).

The thickness of the protective film 30 is not particularly limited, but is preferably 0.5 to 4 micrometers, and more preferably 0.5 to 3 micrometers. When the thickness of the protective film 30 is within the above range, it is possible to obtain an excellent electrolyte solution permeability-retention capability, and suppress an increase in internal resistance of the electrode.

The electrical storage device electrode 100 produced as described above exhibits blocking resistance due to the anti-blocking agent that bleeds out from the surface of the protective film 30. Moreover, a short circuit does not occur due to the presence of the protective film even if dendrites precipitate during repeated charge and discharge. This makes it possible to maintain the functions of the electrical storage device.

### 3.2. Second Specific Example

FIG. 2 is a cross-sectional view schematically illustrating an electrical storage device electrode according to a second specific example. As illustrated in FIG. 2, an electrical storage device electrode 200 includes a collector 110, and an active material layer 120 that is formed on the surface of the collector 110. The active material layer 120 includes an anti-blocking agent, and also functions as a protective film. Although the electrical storage device electrode 200 illustrated in FIG. 2 has a configuration in which the active material layer 120 is formed on only one side of the collector 110 that extends along the longitudinal direction, the active material layer 120 may be formed on each side of the collector 110. When producing an electrical storage device, an electrode and a separator are positioned and stacked to obtain a laminate, and the laminate is formed (e.g., wound) (see above). Therefore, when the electrical storage device electrode 200 has a configuration in which the active material layer 120 is formed on at least the surface that comes in contact with the separator, the electrical storage device electrode 200 exhibits blocking resistance, and it is possible to prevent a situation in which removal (fall) of the active material and the like occurs due to forming.

The active material layer 120 is a layer that is formed by applying an electrical storage device electrode slurry that includes a binder, an active material, and an anti-blocking agent to the surface of the collector 110, and drying the applied electrical storage device electrode slurry. The electrical storage device electrode slurry is described in detail later. The electrical storage device electrode 200 according to the second specific example (second embodiment) is configured in the same manner as the electrical storage device electrode 100 according to the first specific example (first embodiment) (see FIG. 1), except for the above features. Therefore, further description thereof is omitted.

The electrical storage device electrode 200 produced as described above exhibits blocking resistance due to the anti-blocking agent that bleeds out from the surface of the active material layer 120.

### 4. ELECTRICAL STORAGE DEVICE SEPARATOR

An electrical storage device separator according to one embodiment of the invention includes a protective film that is provided on the surface thereof, the protective film including a binder and an anti-blocking agent, the content (M1 parts by mass) of the binder and the content (M2 parts by mass) of the anti-blocking agent in the protective film satisfying the relationship “1<M1/M2<4,000”. Note that the binder, the anti-blocking agent, and the relationship between the content of the binder and the content of the anti-blocking agent are the same as described above in connection with the electrical storage device composition, and description thereof is omitted. The electrical storage device separator according to one embodiment of the invention is described below with reference to FIG. 3.

FIG. 3 is a cross-sectional view schematically illustrating the electrical storage device separator according to one embodiment of the invention. As illustrated in FIG. 3, an electrical storage device separator 300 includes a separator 240, and a protective film 230 that is formed on the surface of the separator 240. Although the electrical storage device separator 300 illustrated in FIG. 3 has a configuration in which the protective film 230 is formed on only one side of the separator 240 that extends along the longitudinal direction, the protective film 230 may be formed on each side of the separator 240. When producing an electrical storage device, an electrode and a separator are positioned and stacked to obtain a laminate, and the laminate is formed (e.g., wound) (see above). Therefore, when the electrical storage device separator 300 has a configuration in which the protective film 230 is formed on at least the surface that comes in contact with the electrode, the electrical storage device separator 300 exhibits blocking resistance, and it is possible to prevent a situation in which removal (fall) of the active material and the like occurs due to forming.

The separator 240 is not particularly limited as long as the separator 240 is electrically stable, is chemically stable to an active material and a solvent, and does not have electrical conductivity. For example, a polymer nonwoven fabric, a porous film, or a sheet formed using glass or ceramic fibers may be used as the separator 240. A laminate of these materials may also be used as the separator 240. It is particularly preferable to use a porous polyolefin film as the separator 240. A composite of a porous polyolefin film and a heat-resistant material (e.g., polyimide, glass, or ceramic fibers) may also be used as the separator 240.

The protective film 230 may be formed by applying the protective film-forming slurry (see above) to the surface of the separator 240, and drying the applied protective film-forming slurry, for example. The protective film-forming slurry may be applied to the surface of the separator 240 using a doctor blade method, a reverse roll method, a comma bar method, a gravure method, an air knife method, a die coating method, or the like. The resulting film is preferably dried at 20 to 250° C. (more preferably 50 to 150° C.) for 1 to 120 minutes (more preferably 5 to 60 minutes).

When a functional layer that does not include an anti-blocking agent is formed on the surface of the separator 240, the protective film 230 may be formed on the surface of the functional layer by applying the protective film-forming slurry to the surface of the functional layer, and drying the applied protective film-forming slurry. The separator can thus be provided with blocking resistance.

The electrical storage device separator 300 produced as described above exhibits blocking resistance due to the anti-blocking agent that bleeds out from the surface of the protective film 230. Moreover, a short circuit does not occur due to the presence of the protective film even if dendrites precipitate during repeated charge and discharge. This makes it possible to maintain the functions of the electrical storage device.

### 5. ELECTRICAL STORAGE DEVICE

An electrical storage device according to one embodiment of the invention includes at least one of the electrical storage device electrode and the separator that includes the protective film (see above). The electrical storage device may be produced by stacking a positive electrode and a negative electrode on either side of a separator (that prevent a short circuit between the positive electrode and the negative electrode), or sequentially stacking a positive electrode, a separator, a negative electrode, and a separator to form an electrode/separator laminate, winding or folding the electrode/separator laminate in the shape of a battery, placing the electrode/separator laminate in a battery casing, injecting an electrolyte solution into the battery casing, and sealing the battery casing, for example. When the electrode is the electrical storage device electrode (see above), moderate blocking is achieved when forming the electrode/separator laminate, and displacement between the electrode and the separator can be effectively prevented. Since the electrode exhibits blocking resistance, removal of the active material layer can be prevented when winding or folding the electrode/separator laminate in the shape of a battery, for example. This also applies to the case where the separator is the separator that includes the protective film (see above). The battery may have an arbitrary shape (e.g., coin, button, sheet, cylinder, square, or flat shape).

The electrolyte solution may be in the form of a liquid or gel. The electrolyte solution may be selected from known electrolyte solutions used for an electrical storage device taking account of the type of the active material so that the function of the battery is effectively achieved. The electrolyte solution may be a solution prepared by dissolving an electrolyte in an appropriate solvent.

An arbitrary known lithium salt may be used as the electrolyte used when producing a lithium-ion secondary battery. Specific examples of the lithium salt include LiClO₄, LiBF₄, LiPF₆, LiCF₃CO₂, LiAsF₆, LiSbF₆, LiB₁₀Cl₁₀, LiAlCl₄, LiCl, LiBr, LiB(C₂H₅)₄, LiCF₃SO₃, LiCH₃SO₃, LiC₄F₉SO₃, Li(CF₃SO₂)₂N, a lithium lower aliphatic carboxylate, and the like. When producing a nickel-hydrogen secondary battery, a potassium hydroxide aqueous solution (concentration: 5 mol/L or more) may be used as the electrolyte solution, for example.

The solvent used to dissolve the electrolyte is not particularly limited. Specific examples of the solvent include a carbonate compound such as propylene carbonate, ethylene carbonate, butylene carbonate, dimethyl carbonate, methylethyl carbonate, and diethyl carbonate; a lactone compound such as gamma-butyrolactone; an ether compound such as trimethoxymethane, 1,2-dimethoxyethane, diethyl ether, 2-ethoxyethane, tetrahydrofuran, and 2-methyltetrahydrofuran; a sulfoxide compound such as dimethyl sulfoxide; and the like. The solvent may be one or more compounds selected from these compounds. The concentration of the electrolyte in the electrolyte solution is preferably 0.5 to 3.0 mol/L, and more preferably 0.7 to 2.0 mol/L.

When the electrode/separator laminate is placed in the battery casing, and the electrolyte solution is injected into the battery casing, the anti-blocking agent that has bled out from the surface of the electrode and/or the separator is eluted into the electrolyte solution. Specifically, the anti-blocking agent is thus removed from the surface of the electrode and/or the separator to obtain an electrical storage device that exhibits excellent charge-discharge rate characteristics (i.e., electrical characteristics).

### 6. EXAMPLES

The invention is further described below by way of examples. Note that the invention is not limited to the following examples. Note that the units “parts” and “%” used in connection with the examples and comparative examples refer to “parts by mass” and “mass %” unless otherwise indicated.

### 6.1. Example 1

### 6.1.1. Production of Binder

An autoclave (internal volume: about 6 L) equipped with an electromagnetic stirrer in which the internal atmosphere had been sufficiently replaced with nitrogen, was charged with 2.5 L of deoxidized purified water and 25 g of ammonium perfluorodecanoate (emulsifier). The mixture was heated to 60° C. with stirring at 350 rpm. The autoclave was then charged with a mixed gas including vinylidene fluoride (VDF) (70%) and hexafluoropropylene (HFP) (30%) (monomers) until the internal pressure reached 20 kg/cm². 25 g of a CFC-113 solution including 20% of diisopropyl peroxydicarbonate (initiator) was injected into the autoclave using nitrogen gas to initiate polymerization. The internal pressure was maintained at 20 kg/cm² during polymerization by successively injecting a mixed gas including VDF (60.2%) and HFP (39.8%). Since the polymerization rate decreased along with the progress of polymerization, 25 g of a CFC-113 solution including 20% of diisopropyl peroxydicarbonate was injected again using nitrogen gas when 3 hours had elapsed, and the monomers were polymerized for a further 3 hours. The reaction mixture was then cooled without stirring, and unreacted monomers were removed to obtain an aqueous dispersion including fine particles of a polymer (content: 40%). The mass ratio (VDF/HFP) of VDF to HFP in the polymer determined by ¹⁹F-NMR analysis was 21/4.

A 7 L separable flask in which the internal atmosphere had been sufficiently replaced with nitrogen, was charged with 1,600 g of the aqueous dispersion including the fine particles of the polymer (polymer: 25 parts by mass), 0.5 parts by mass of an emulsifier “Adeka Reasoap SR1025” (manufactured by Adeka Corporation), 30 parts by mass of methyl methacrylate (MMA), 40 parts by mass of 2-ethylhexyl acrylate (EHA), 5 parts by mass of methacrylic acid (MAA), and 130 parts by mass of water. The mixture was stirred at 70° C. for 3 hours (i.e., the monomers were absorbed in the polymer). After the addition of 20 mL of a tetrahydrofuran solution including 0.5 parts by mass of azobisisobutyronitrile (oil-soluble initiator), the mixture was reacted at 75° C. for 3 hours, and then reacted at 85° C. for 2 hours. After cooling the mixture to terminate the reaction, the pH of the mixture was adjusted to 7 using a 2.5 N sodium hydroxide aqueous solution to obtain an aqueous dispersion including a binder (binder particles) (content: 40%).

The particle size distribution of the aqueous dispersion including the binder particles (content: 40%) was measured using a dynamic light scattering particle size analyzer (“FPAR-1000” manufactured by Otsuka Electronics Co., Ltd.), and the modal particle size was determined from the particle size distribution. The average particle size was thus calculated to be 330 nm.

### 6.1.2. Preparation of Electrical Storage Device Composition

5 g of an aqueous suspension including calcium stearate (50 mass %) was added to 1,000 g of the aqueous dispersion including the binder particles. The mixture was stirred at 300 rpm to prepare an electrical storage device composition S1. In the examples and comparative examples, when the anti-blocking agent was insoluble in water, a dispersion (suspension) prepared by dispersing the anti-blocking agent in water at a concentration of 50 mass % was added when preparing the electrical storage device composition.

### 6.1.3. Preparation of Electrical Storage Device Slurry

A twin-screw planetary mixer (“TK HIVIS MIX 2P-03” manufactured by PRIMIX Corporation) was charged with 1 part by mass (on a solid basis) of a thickener (“CMC1120” manufactured by Daicel Corporation), 100 parts by mass of an active material (particle size (D50): 0.5 micrometers) (obtained by grinding commercially available lithium iron phosphate (LiFePO₄) using an agate mortar, and classifying the ground product using a sieve), 5 parts by mass of acetylene black, and 68 parts by mass of water. The mixture was stirred at 60 rpm for 1 hour. The electrical storage device composition S1 prepared as described was added to the mixture so that the content of the binder particles in the composition was 1 part by mass, and the resulting mixture was stirred for 1 hour to obtain a paste. After the addition of water to the paste to adjust the solid content to 50%, the resulting mixture was stirred at 200 rpm for 2 minutes, stirred at 1,800 rpm for 5 minutes, and stirred at 1,800 rpm for 1.5 minutes under vacuum (about 5.0×10³ Pa) using a stirrer/deaerator (“THINKY Mixer (Awatori Rentarou)” manufactured by THINKY Corporation) to prepare an electrical storage device slurry.

### 6.1.4. Production and Evaluation of Electrical Storage Device Electrode

The electrical storage device slurry prepared as described above was uniformly applied to the surface of an aluminum foil collector (thickness: 30 micrometers) using a doctor blade method so that the film thickness after drying was 100 micrometers. The resulting film was dried at 120° C. for 20 minutes. The film was then pressed using a roll press so that the resulting active material layer had the density shown in Table 1 to obtain an electrode (positive electrode).

### <Evaluation of Inter-Electrode Blocking Resistance>

Two electrodes produced as described above were stacked so that the active material layers faced each other, and allowed to stand at 30° C. for 24 hours under a pressure of 10 g/cm². The inter-electrode blocking resistance was evaluated based on the presence or absence of removal of the active material when the electrodes were separated. Note that the following evaluation standard was used. The evaluation results are shown in Table 1.

The inter-electrode blocking resistance was evaluated as “Good” when the electrodes could be easily separated while preventing removal of the active material (i.e., blocking was suppressed).

The inter-electrode blocking resistance was evaluated as “Bad” when the electrodes could not be easily separated, and removal of the active material was observed when the electrodes were separated (i.e., excessive blocking was observed).

### <Evaluation of Electrode-Separator Blocking Resistance>

An electrode produced as described above was stacked on a separator formed of a porous polypropylene membrane (“Celgard #2400” manufactured by Celgard LLC) so that the active material layer faced the separator, and the laminate was allowed to stand at 30° C. for 24 hours under a pressure of 10 g/cm². The electrode-separator blocking resistance was evaluated by sensory evaluation based on the force required to separate the electrode from the separator. Note that the following evaluation standard was used. The evaluation results are shown in Table 1.

The electrode-separator blocking resistance was evaluated as “Good” when a considerable force was required to separate the electrode from the separator (i.e., moderate blocking was observed).

The inter-electrode blocking resistance was evaluated as “Bad” when the electrode could be easily separated from the separator (i.e., blocking was suppressed excessively).

### 6.1.5. Production and Evaluation of Electrical Storage Device

### <Production of Counter Electrode (Negative Electrode)>

A twin-screw planetary mixer (“TK HIVIS MIX 2P-03” manufactured by PRIMIX Corporation) was charged with 4 parts by mass (on a solid basis) of polyvinylidene fluoride (PVDF), 100 parts by mass (on a solid basis) of graphite (negative electrode active material), and 80 parts by mass of N-methylpyrrolidone (NMP). The mixture was stirred at 60 rpm for 1 hour. After the addition of 20 parts by mass of NMP, the mixture was stirred at 200 rpm for 2 minutes, stirred at 1,800 rpm for 5 minutes, and stirred at 1,800 rpm for 1.5 minutes under vacuum using a stirrer/deaerator (“THINKY Mixer (Awatori Rentarou)” manufactured by THINKY Corporation) to prepare a counter electrode (negative electrode) slurry.

The counter electrode (negative electrode) slurry thus prepared was uniformly applied to the surface of a copper foil collector using a doctor blade method so that the film thickness after drying was 150 micrometers. The resulting film was dried at 120° C. for 20 minutes. The film was then pressed using a roll press so that the film had a density of 1.5 g/cm³ to obtain a counter electrode (negative electrode).

### <Assembly of Lithium-Ion Battery Cell>

In a gloved box in which the internal atmosphere was replaced with argon (Ar) so that the dew point was −80° C., a negative electrode (diameter: 15.95 mm) prepared by punching the negative electrode produced as described above was placed on a two-electrode coin cell (“HS Flat Cell” manufactured by Hohsen Corp.). A separator (“Celgard #2400” manufactured by Celgard, LLC.) (diameter: 24 mm) prepared by punching a polypropylene porous membrane was placed on the negative electrode, and 500 microliters of an electrolyte solution was injected into the two-electrode coin cell while avoiding the entrance of air. A positive electrode (diameter: 16.16 mm) prepared by punching the positive electrode produced as described above was placed on the separator, and the outer casing of the two-electrode coin cell was air-tightly secured using a screw to assemble a lithium-ion battery cell (electrical storage device). Note that the electrolyte solution was prepared by dissolving LiPF₆ in ethylene carbonate/ethylmethyl carbonate (mass ratio=1/1) at a concentration of 1 mol/L.

### <Evaluation of Charge-Discharge Rate Characteristics>

The electrical storage device produced as described above was charged at a constant current of 0.2 C until the voltage reached 4.2 V. The electrical storage device was continuously charged at a constant voltage of 4.2 V. The current was cut off (i.e., the electrical storage device was determined to be fully charged) when the current value reached 0.01 C, and the charge capacity at 0.2 C was measured. The electrical storage device was then discharged at a constant current of 0.2 C. The current was cut off (i.e., the electrical storage device was determined to be fully discharged) when the voltage reached 2.7 V, and the discharge capacity at 0.2 C was measured.

The electrical storage device was then charged at a constant current of 3 C. After the voltage reached 4.2 V, the electrical storage device was continuously charged at a voltage of 4.2 V. The current was cut off (i.e., the electrical storage device was determined to be fully charged) when the current value reached 0.01 C, and the charge capacity at 3 C was measured. The electrical storage device was then discharged at a constant current of 3 C. The current was cut off (i.e., the electrical storage device was determined to be fully discharged) when the voltage reached 2.7 V, and the discharge capacity at 3 C was measured.

The charge rate (%) of the electrical storage device was determined by calculating the ratio (%) of the charge capacity at 3 C to the charge capacity at 0.2 C. The discharge rate (%) of the electrical storage device was determined by calculating the ratio (%) of the discharge capacity at 3 C to the discharge capacity at 0.2 C. The following evaluation standard was used. The evaluation results are shown in Table 1.

When the charge rate and the discharge rate were 80% or more, the charge-discharge rate characteristics were evaluated as “Good”.

When at least one of the charge rate and the discharge rate was less than 80%, the charge-discharge rate characteristics were evaluated as “Bad”.

Note that “1 C” refers to a current value that requires 1 hour to fully discharge a cell having a constant electric capacitance. For example, “0.1 C” refers to a current value that requires 10 hours to fully discharge a cell, and “10 C” refers to a current value that requires 0.1 hours to fully discharge a cell.

### 6.2. Examples 2 to 7 and Comparative Examples 1 to 3

An aqueous dispersion including a binder having the composition shown in Table 1 was prepared in the same manner as in Example 1 (see “6.1.1. Production of binder”), except that the monomer composition and the amount of the emulsifier were appropriately changed. Water was removed under reduced pressure, or added, depending on the solid content in the aqueous dispersion to obtain an aqueous dispersion having a solid content of 40%.

An electrical storage device composition (S2 to S7 and S11 to S13) was prepared in the same manner as in Example 1 (see “6.1.2. Preparation of electrical storage device composition”), except that the type and the amount of the anti-blocking agent were changed as shown in Table 1.

An electrical storage device electrode slurry was prepared in the same manner as in Example 1 (see “6.1.3. Preparation of electrode slurry”), an electrical storage device electrode was produced and evaluated in the same manner as in Example 1 (see “6.1.4. Production and evaluation of electrical storage device electrode”), and an electrical storage device was produced and evaluated in the same manner as in Example 1 (see “6.1.5. Production and evaluation of electrical storage device”). The results are shown in Table 1.

### 6.3. Example 8

A 7 L separable flask was charged with 150 parts by mass of water and 0.2 parts by mass of sodium dodecylbenzenesulfonate, and the internal atmosphere of the separable flask was sufficiently replaced with nitrogen. Another container was charged with 60 parts by mass of water, 0.8 parts by mass (on a solid basis) of an ether sulfate emulsifier (“Adeka Reasoap SR1025” manufactured by Adeka Corporation) (emulsifier), 20 parts by mass of 2,2,2-trifluoroethyl methacrylate (TFEMA) (monomer), 10 parts by mass of acrylonitrile (AN) (monomer), 25 parts by mass of methyl methacrylate (MMA) (monomer), 40 parts by mass of 2-ethylhexyl acrylate (EHA) (monomer), and 5 parts by mass of acrylic acid (AA) (monomer). The mixture was sufficiently stirred to obtain a monomer emulsion including the monomer mixture. The inside of the separable flask was heated to 60° C., and 0.5 parts by mass of ammonium persulfate (initiator) was added to the separable flask. When the temperature inside the separable flask reached 70° C., the monomer emulsion was slowly added to the separable flask over 3 hours while maintaining the temperature inside the separable flask at 70° C. After increasing the temperature inside the separable flask to 85° C., the monomers were polymerized at 85° C. for 3 hours. After cooling the separable flask to terminate the reaction, the pH of the mixture was adjusted to 7.6 using aqueous ammonia to obtain an aqueous dispersion including a binder (binder particles) (content: 40%).

An electrical storage device composition S8 and an electrical storage device slurry were prepared, and an electrical storage device electrode and an electrical storage device were produced and evaluated in the same manner as in Example 1, except that the resulting aqueous dispersion was used, and the type and the amount of the anti-blocking agent were changed as shown in Table 1. The results are shown in Table 1.

### 6.4. Examples 9 and 10

An aqueous dispersion including a binder having the average particle size shown in Table 1 was obtained in the same manner as in Example 8, except that the type and the amount (parts) of each monomer were changed as shown in Table 1. An electrical storage device composition (S9 and S10) and an electrical storage device slurry were prepared, and an electrical storage device electrode and an electrical storage device were produced and evaluated in the same manner as in Example 1, except that the resulting aqueous dispersion was used. The results are shown in Table 1.

### 6.5. Example 11

### 6.5.1. Production of Binder

A temperature-adjustable autoclave equipped with a stirrer was charged with 200 parts by mass of water, 0.6 parts by mass of sodium dodecylbenzene sulfonate, 1.0 part by mass of potassium persulfate, 0.5 parts by mass of sodium hydrogen sulfite, 0.2 parts by mass of an alpha-methylstyrene dimer, 0.2 parts by mass of dodecylmercaptan, and the first-stage polymerization components shown in Table 2. The mixture was heated to 70° C., and polymerized for 2 hours. After confirming that the polymerization conversion ratio was 80% or more, the second-stage polymerization components shown in Table 2 were added to the mixture over 6 hours while maintaining the reaction temperature at 70° C. When 3 hours had elapsed after the start of addition of the second-stage polymerization components, 1.0 part by mass of an alpha-methylstyrene dimer and 0.3 parts by mass of dodecylmercaptan were added to the mixture. After the addition of the second-stage polymerization components, the mixture was heated to 80° C., and reacted for 2 hours. After completion of polymerization, the pH of the resulting latex was adjusted to 7.5, followed by the addition of 5 parts by mass (on a solid basis) of potassium tripolyphosphate. The residual monomers were removed by steam distillation, and the residue was concentrated under reduced pressure until the solid content reached 30% to obtain an aqueous dispersion including a binder (content: 30%).

The particle size distribution of the aqueous dispersion including the binder (binder particles) was measured using a dynamic light scattering particle size analyzer (“FPAR-1000” manufactured by Otsuka Electronics Co., Ltd.), and the modal particle size was determined from the particle size distribution. The average particle size was thus calculated to be 200 nm.

### 6.5.2. Preparation of Electrical Storage Device Composition

An electrical storage device composition S14 was prepared in the same manner as in Example 1, except that the resulting aqueous dispersion was used, and the type and the amount of the anti-blocking agent were changed as shown in Table 1.

### 6.5.3. Preparation of Electrical Storage Device Slurry

A twin-screw planetary mixer (“TK HIVIS MIX 2P-03” manufactured by PRIMIX Corporation) was charged with 1 part by mass (on a solid basis) of a thickener (“CMC2200” manufactured by Daicel Corporation), 100 parts by mass (on a solid basis) of graphite (negative electrode active material), and 68 parts by mass of water. The mixture was stirred at 60 rpm for 1 hour. After the addition of 2 parts by mass (on a solid basis) of the electrical storage device composition S14, the mixture was stirred for 1 hour to obtain a paste. After the addition of water to the paste to adjust the solid content to 50%, the mixture was stirred at 200 rpm for 2 minutes, stirred at 1,800 rpm for 5 minutes, and then stirred at 1,800 rpm for 1.5 minutes under vacuum, using a stirrer/deaerator (“THINKY Mixer (Awatori Rentarou)” manufactured by THINKY Corporation) to prepare an electrical storage device slurry.

### 6.5.4. Production and Evaluation of Electrical Storage Device Electrode

The electrical storage device slurry prepared as described above was uniformly applied to the surface of a copper foil collector (thickness: 20 micrometers) using a doctor blade method so that the film thickness after drying was 80 micrometers. The resulting film was dried at 120° C. for 20 minutes. The film was pressed using a roll press so that the resulting active material layer had the density shown in Table 1 to obtain an electrical storage device electrode (negative electrode). The blocking resistance of the resulting electrical storage device electrode was evaluated in the same manner as described above (see “6.1.4. Production and evaluation of electrical storage device electrode”). The results are shown in Table 1.

### 6.5.5. Production and Evaluation of Electrical Storage Device

### <Production of Counter Electrode (Positive Electrode)>

A twin-screw planetary mixer (“TK HIVIS MIX 2P-03” manufactured by PRIMIX Corporation) was charged with 4.0 parts by mass (on a solid basis) of an electrochemical device electrode binder (“KF Polymer #1120” manufactured by Kureha Corporation), 3.0 parts by mass of a conductive aid (“DENKA BLACK” 50% pressed product, manufactured by Denki Kagaku Kogyo Kabushiki Kaisha), 100 parts by mass of LiCoO₂ (particle size: 5 micrometers, manufactured by Hayashi Kasei Co., Ltd.) (positive electrode active material), and 36 parts by mass of N-methylpyrrolidone (NMP). The mixture was stirred at 60 rpm for 2 hours to prepare a paste. After the addition of NMP to the paste to adjust the solid content to 65%, the mixture was stirred at 200 rpm for 2 minutes, stirred at 1,800 rpm for 5 minutes, and then stirred at 1,800 rpm for 1.5 minutes under vacuum using a stirrer/deaerator (“THINKY Mixer (Awatori Rentarou)” manufactured by THINKY Corporation) to prepare an electrode slurry. The electrode slurry was uniformly applied to the surface of an aluminum foil collector using a doctor blade method so that the film thickness after drying was 80 micrometers. The resulting film was dried at 120° C. for 20 minutes. The film was pressed using a roll press so that the resulting active material layer had a density of 3.0 g/cm³ to obtain a counter electrode (positive electrode).

### <Assembly of Lithium-Ion Battery Cell>

In a gloved box in which the internal atmosphere was replaced with argon (Ar) so that the dew point was −80° C., a negative electrode (diameter: 15.95 mm) prepared by punching the negative electrode produced as described above was placed on a two-electrode coin cell (“HS Flat Cell” manufactured by Hohsen Corp.). A separator (“Celgard #2400” manufactured by Celgard, LLC.) (diameter: 24 mm) prepared by punching a polypropylene porous membrane was placed on the negative electrode, and 500 microliters of an electrolyte was injected into the two-electrode coin cell while avoiding the entrance of air. A positive electrode (diameter: 16.16 mm) prepared by punching the positive electrode produced as described above (see “Production of counter electrode (positive electrode)”) was placed on the separator, and the outer casing of the two-electrode coin cell was air-tightly secured using a screw to assemble a lithium-ion battery cell (electrical storage device). Note that the electrolyte solution was prepared by dissolving LiPF₆ in ethylene carbonate/ethylmethyl carbonate (mass ratio=1/1) at a concentration of 1 mol/L. The charge-discharge rate characteristics of the electrical storage device were evaluated in the same manner as described above (see “6.1.6. Production and evaluation of electrical storage device”). The results are shown in Table 1.

### 6.6. Examples 12 and 13 and Comparative Examples 4 to 6

An aqueous dispersion including a binder having the composition shown in Table 1 was prepared in the same manner as in Example 11 (see “6.5.1. Production of binder”), except that the monomer composition was changed as shown in Table 2, and the amount of the emulsifier was appropriately changed. Water was removed under reduced pressure, or added, depending on the solid content in the aqueous dispersion to obtain an aqueous dispersion including a binder (binder particles) (content: 30%).

An electrical storage device composition (S15 to S19) was prepared in the same manner as in Example 11 (see “6.5.2. Preparation of electrical storage device composition”), except that the type and the amount of the anti-blocking agent were changed as shown in Table 1.

An electrical storage device electrode slurry was prepared in the same manner as in Example 11 (see “6.5.3. Preparation of electrode slurry”), an electrical storage device electrode was produced and evaluated in the same manner as in Example 11 (see “6.5.4. Production and evaluation of electrical storage device electrode”), and an electrical storage device was produced and evaluated in the same manner as in Example 11 (see “6.5.5. Production and evaluation of electrical storage device”). The results are shown in Table 1.

The electrical storage device compositions of Examples 1 to 13 and Comparative Examples 1 to 6 and the evaluation results for the electrical storage device compositions of Examples 1 to 13 and Comparative Examples 1 to 6 are shown in Table 1. The content of the first-stage polymerization component and the content of the second-stage polymerization component when preparing the aqueous dispersions including the binder of Examples 11 to 13 and Comparative Examples 4 to 6 are shown in Table 2.

TABLE 1

| | | Example 1 | Example 2 | Example 3 | Example 4 | Example 5 | Example 6 | Example 7 |
|---|---|---|---|---|---|---|---|---|
| Electrical storage device composition | | S1 | S2 | S3 | S4 | S5 | S6 | S7 |
| Binder | | Fluorine-containing binder | | | | | | |
| Composition of binder | VDF (parts by mass) | 21 | 20 | 24 | 21 | 30 | 21 | 21 |
| | HFP (parts by mass) | 4 | 5 | 1 | 4 | 4 | 4 | 4 |
| | TFEMA (parts by mass) | — | — | — | — | — | — | — |
| | TFEA (parts by mass) | — | — | — | — | — | — | — |
| | HFIPA (parts by mass) | — | — | — | — | — | — | — |
| | MMA (parts by mass) | 30 | 30 | 30 | 40 | 30 | 50 | 15 |
| | EHA (parts by mass) | 40 | 40 | 40 | 30 | 31 | 20 | 55 |
| | HEMA (parts by mass) | — | — | — | — | — | — | — |
| | MAA (parts by mass) | 5 | — | 5 | 5 | 5 | 5 | — |
| | AA (parts by mass) | — | 5 | — | — | — | — | 5 |
| | TA (parts by mass) | — | — | — | — | — | — | — |
| | DVB (parts by mass) | — | — | — | — | — | — | — |
| | TMPTMA (parts by mass) | — | — | — | — | — | — | — |
| | AN (parts by mass) | — | — | — | — | — | — | — |
| | BD (parts by mass) | — | — | — | — | — | — | — |
| | ST (parts by mass) | — | — | — | — | — | — | — |
| Properties of binder | Average particle size (nm) | 330 | 210 | 330 | 330 | 330 | 330 | 330 |
| particles | Glass transition temperature (° C.) | −11 | −15 | −10 | 12 | −1 | 39 | 44 |
| Binder content M1 (parts by mass) | | 400 | 400 | 400 | 400 | 400 | 400 | 400 |
| Anti-blocking agent | Calcium stearate (parts by mass) | 2.5 | — | — | — | — | — | — |
| content M2 (parts by | Lithium stearate (parts by mass) | — | 5 | — | — | — | — | — |
| mass) | Stearic acid amide (parts by mass) | — | — | — | 0.4 | — | — | — |
| | Stearyl stearate (parts by mass) | — | — | — | — | — | 3 | — |
| | Isopropyl palmitate (parts by mass) | — | — | — | — | — | — | 15 |
| | Polyethylene wax (parts by mass) | — | — | — | — | 0.7 | — | — |
| | Polypropylene wax (parts by mass) | — | — | 0.2 | — | — | — | — |
| Properties of | Melting point (° C.) | 148 | 220 | 128 | 101 | 59 | 55 | 12 |
| anti-blocking agent | | | | | | | | |
| M1/M2 | | 160 | 80 | 2000 | 1000 | 571 | 133 | 27 |
| Properties of electrode | Density (g/cm³) of active material layer | 1.6 | 1.8 | 2.4 | 1.7 | 2 | 2.2 | 1.8 |
| | Inter-electrode blocking resistance | Good | Good | Good | Good | Good | Good | Good |
| | Electrode-separator blocking resistance | Good | Good | Good | Good | Good | Good | Good |
| Properties of electrical | Evaluation of charge-discharge rate | Good | Good | Good | Good | Good | Good | Good |
| storage device | characteristics | | | | | | | |

| | | | | | Comparative | Comparative | Comparative |
|---|---|---|---|---|---|---|---|
| | | Example 8 | Example 9 | Example 10 | Example 1 | Example 2 | Example 3 |
| Electrical storage device composition | | S8 | S9 | S10 | S11 | S12 | S13 |
| Binder | | Fluorine-containing binder | | | | | |
| Composition of binder | VDF (parts by mass) | — | — | — | 16 | 42 | 20 |
| | HFP (parts by mass) | — | — | — | 4 | 5 | 5 |
| | TFEMA (parts by mass) | 20 | — | — | — | — | — |
| | TFEA (parts by mass) | — | 20 | — | — | — | — |
| | HFIPA (parts by mass) | — | — | 20 | — | — | — |
| | MMA (parts by mass) | 25 | 9 | 30 | 35 | 43 | 30 |
| | EHA (parts by mass) | 40 | 40 | 40 | 40 | 5 | 40 |
| | HEMA (parts by mass) | — | — | — | — | — | — |
| | MAA (parts by mass) | — | — | — | 5 | 5 | — |
| | AA (parts by mass) | 5 | 5 | 5 | — | — | 5 |
| | TA (parts by mass) | — | — | — | — | — | — |
| | DVB (parts by mass) | — | 0.5 | — | — | — | — |
| | TMPTMA (parts by mass) | — | 0.5 | — | — | — | — |
| | AN (parts by mass) | 10 | 25 | 5 | — | — | — |
| | BD (parts by mass) | — | — | — | — | — | — |
| | ST (parts by mass) | — | — | — | — | — | — |
| Properties of binder | Average particle size (nm) | 110 | 250 | 300 | 330 | 330 | 330 |
| particles | Glass transition temperature (° C.) | 15 | 18 | 5 | −10 | 71 | −15 |
| Binder content M1 (parts by mass) | | 400 | 400 | 400 | 400 | 400 | 400 |
| Anti-blocking agent | Calcium stearate (parts by mass) | — | — | 1 | — | — | — |
| content M2 (parts by | Lithium stearate (parts by mass) | 10 | — | — | — | — | — |
| mass) | Stearic acid amide (parts by mass) | — | 0.5 | — | — | — | — |
| | Stearyl stearate (parts by mass) | — | — | — | — | — | — |
| | Isopropyl palmitate (parts by mass) | — | — | — | — | — | — |
| | Polyethylene wax (parts by mass) | — | — | — | — | — | 450 |
| | Polypropylene wax (parts by mass) | — | — | — | — | 0.08 | — |
| Properties of | Melting point (° C.) | 220 | 101 | — | — | 128 | 59 |
| anti-blocking agent | | | | | | | |
| M1/M2 | | 40 | 800 | 400 | — | 5000 | 0.9 |
| Properties of electrode | Density (g/cm³) of active material layer | 3.8 | 2.7 | 3.4 | 1.8 | 1.8 | 1.6 |
| | Inter-electrode blocking resistance | Good | Good | Good | Bad | Good | Bad |
| | Electrode-separator blocking resistance | Good | Good | Good | Bad | Bad | Good |
| Properties of electrical | Evaluation of charge-discharge rate | Good | Good | Good | Bad | Bad | Bad |
| storage device | characteristics | | | | | | |

| | | | | | Comparative | Comparative | Comparative |
|---|---|---|---|---|---|---|---|
| | | Example 11 | Example 12 | Example 13 | Example 4 | Example 5 | Example 6 |
| Electrical storage device composition | | S14 | S15 | S16 | S17 | S18 | S19 |
| Binder | | Diene-based binder | | | | | |
| Composition of binder | VDF (parts by mass) | — | — | — | — | — | — |
| | HFP (parts by mass) | — | — | — | — | — | — |
| | TFEMA (parts by mass) | — | — | — | — | — | — |
| | TFEA (parts by mass) | — | — | — | — | — | — |
| | HFIPA (parts by mass) | — | — | — | — | — | — |
| | MMA (parts by mass) | 12 | 22 | 10 | 12 | 12 | 3 |
| | EHA (parts by mass) | — | — | — | — | — | — |
| | HEMA (parts by mass) | — | — | 1 | — | — | — |
| | MAA (parts by mass) | — | — | — | — | — | — |
| | AA (parts by mass) | 1 | 1 | 1 | 1 | 1 | — |
| | TA (parts by mass) | 3 | — | 1 | 3 | 3 | — |
| | DVB (parts by mass) | — | — | — | — | — | — |
| | TMPTMA (parts by mass) | — | — | — | — | — | — |
| | AN (parts by mass) | 12 | 5 | 15 | 12 | 12 | 12 |
| | BD (parts by mass) | 41 | 49 | 52 | 29 | 49 | 65 |
| | ST (parts by mass) | 31 | 23 | 20 | 43 | 23 | 20 |
| Properties of binder | Average particle size (nm) | 200 | 90 | 120 | 200 | 200 | 90 |
| particles | Glass transition temperature (° C.) | 9 | −21 | −23 | 18 | −21 | −62 |
| Binder content M1 (parts by mass) | | 300 | 300 | 300 | 300 | 300 | 300 |
| Anti-blocking agent | Calcium stearate (parts by mass) | 0.5 | — | — | — | — | 0.05 |
| content M2 (parts by | Lithium stearate (parts by mass) | — | 4 | — | — | — | — |
| mass) | Stearic acid amide (parts by mass) | — | — | — | — | — | — |
| | Stearyl stearate (parts by mass) | — | — | — | — | — | — |
| | Isopropyl palmitate (parts by mass) | — | — | — | — | — | — |
| | Polyethylene wax (parts by mass) | — | — | — | — | 400 | — |
| | Polypropylene wax (parts by mass) | — | — | 0.15 | — | — | — |
| Properties of | Melting point (° C.) | 148 | 220 | 128 | — | 59 | 148 |
| anti-blocking agent | | | | | | | |
| M1/M2 | | 600 | 75 | 2000 | — | 0.8 | 6000 |
| Properties of electrode | Density (g/cm³) of active material layer | 1.5 | 1.5 | 1.5 | 1.5 | 1.5 | 1.5 |
| | Inter-electrode blocking resistance | Good | Good | Good | Bad | Bad | Good |
| | Electrode-separator blocking resistance | Good | Good | Good | Bad | Good | Bad |
| Properties of electrical | Evaluation of charge-discharge rate | Good | Good | Good | Bad | Bad | Bad |
| storage device | characteristics | | | | | | |

TABLE 2

| | | | | | Comparative | Comparative | Comparative |
|---|---|---|---|---|---|---|---|
| | | Example 11 | Example 12 | Example 13 | Example 4 | Example 5 | Example 6 |
| First-step polymerization | AN (parts) | 0 | 0 | 0 | 0 | 0 | 0 |
| component | HEMA (parts) | 0 | 0 | 0 | 0 | 0 | 0 |
| | BD (parts) | 6.7 | 6.7 | 6.7 | 6.7 | 6.0 | 6.7 |
| | ST (parts) | 12.0 | 12.0 | 12.0 | 15.0 | 12.0 | 12.0 |
| | MMA (parts) | 2.6 | 2.6 | 2.6 | 2.6 | 2.6 | 2.6 |
| | AA (parts) | 0.6 | 0.3 | 0.6 | 0.6 | 0.6 | 0.0 |
| | TA (parts) | 2.4 | 0 | 1.0 | 2.0 | 1.5 | 0.0 |
| Total | | 24.3 | 21.6 | 22.9 | 26.9 | 22.7 | 21.3 |
| Second-step polymerization | AN (parts) | 12.0 | 5.0 | 15.0 | 12.0 | 12.0 | 12.0 |
| component | HEMA (parts) | 0 | 0 | 1.0 | 0 | 0 | 0 |
| | BD (parts) | 34.3 | 42.3 | 45.3 | 22.3 | 43.0 | 58.3 |
| | ST (parts) | 19.0 | 11.0 | 8.0 | 28.0 | 11.0 | 8.0 |
| | MMA (parts) | 9.4 | 19.4 | 7.4 | 9.4 | 9.4 | 0.4 |
| | AA (parts) | 0.4 | 0.7 | 0.4 | 0.4 | 0.4 | 0.0 |
| | TA (parts) | 0.6 | 0 | 0 | 1.0 | 1.5 | 0.0 |
| Total | | 75.7 | 78.4 | 77.1 | 73.1 | 77.3 | 78.7 |
| First-step polymerization | AN (parts) | 12.0 | 5.0 | 15.0 | 12.0 | 12.0 | 12.0 |
| component + second-step | HEMA (parts) | 0 | 0 | 1.0 | 0 | 0 | 0 |
| polymerization component | BD (parts) | 41.0 | 49.0 | 52.0 | 29.0 | 49.0 | 65.0 |
| | ST (parts) | 31.0 | 23.0 | 20.0 | 43.0 | 23.0 | 20.0 |
| | MMA (parts) | 12.0 | 22.0 | 10.0 | 12.0 | 12.0 | 3.0 |
| | AA (parts) | 1.0 | 1.0 | 1.0 | 1.0 | 1.0 | 0 |
| | TA (parts) | 3.0 | 0.0 | 1.0 | 3.0 | 3.0 | 0 |

| | | | | | | |
|---|---|---|---|---|---|---|
| Total | 100.0 | 100.0 | 100.0 | 100.0 | 100.0 | 100.0 |

The abbreviation of each component shown in Tables 1 and 2 has the following meaning.

VDF: vinylidene fluoride
HFP: hexafluoropropylene
TFEMA: 2,2,2-trifluoroethyl methacrylate
TFEA: 2,2,2-trifluoroethyl acrylate
HFIPA: 1,1,1,3,3,3-hexafluoroisopropyl acrylate
MMA: methyl methacrylate
EHA: 2-ethylhexyl acrylate
HEMA: 2-hydroxyethyl methacrylate
MAA: methacrylic acid
AA: acrylic acid
TA: itaconic acid
DVB: divinylbenzene
TMPTMA: trimethylolpropane trimethacrylate
AN: acrylonitrile
BD: 1,3-butadiene
ST: styrene

### 6.7. Example 14

### 6.7.1. Preparation of Protective Film-Forming Slurry

20 parts by mass (based on 100 parts by mass of water) of titanium oxide (“KR380” manufactured by Titan Kogyo Ltd., rutile type, average particle size: 0.38 micrometers) (inorganic particles), 5 parts by mass (solid basis) (based on the inorganic particles) of the electrical storage device composition S1 obtained as described above (see “6.1.2. Preparation of electrical storage device composition” (see Example 1), and 1 part by mass of a thickener (“CMC1120” manufactured by Daicel Corporation) were mixed and dispersed using a mixer (“T.K. Film (registered trademark) Model 56-50” manufactured by PRIMIX Corporation) to prepare a protective film-forming slurry in which titanium oxide was dispersed.

### 6.7.2. Production of Positive Electrode

The protective film-forming slurry obtained as described above was applied to the surface of the active material layer of the positive electrode produced as described above (see “6.5.5. Production and evaluation of electrical storage device” (see Example 11)) using a die coating method, and dried at 120° C. for 5 minutes to form a protective film on the surface of the active material layer. The thickness of the protective film was 3 micrometers. The positive electrode was evaluated in the same manner as in Example 1 (see “6.1.4. Production and evaluation of electrical storage device electrode”). The results are shown Table 3.

### 6.7.3. Negative Electrode

The negative electrode produced as described above (see “6.1.5. Production and evaluation of electrical storage device” (see Example 1)) was used.

### 6.7.4. Assembly of Lithium-Ion Battery Cell

An electrical storage device was produced and evaluated in the same manner as described above (see “6.1.5. Production and evaluation of electrical storage device” (see Example 1)). The results are shown in Table 3.

### 6.8. Examples 15 to 23 and Comparative Examples 7 to 9

A positive electrode was produced and evaluated in the same manner as in Example 14, except that the electrical storage device compositions S2 to S13 were respectively used, and the inorganic particles shown Table 3 were used. An electrical storage device was produced and evaluated in the same manner as in Example 14. The results are shown in Table 3.

### 6.9. Examples 24 to 26 and Comparative Examples 10 to 12

A protective film-forming slurry was prepared in the same manner as in Example 14, except that the electrical storage device compositions S14 to S19 were respectively used, and the inorganic particles shown in Table 4 were used.

The protective film-forming slurry obtained as described above was applied to the surface of the active material layer of the negative electrode produced as described above (see “6.5.4. Production and evaluation of electrical storage device electrode” (see Example 11)) using a die coating method, and dried at 120° C. for 5 minutes to form a protective film on the surface of the active material layer. The resulting negative electrode was evaluated in the same manner as in Example 1 (see “6.1.4. Production and evaluation of electrical storage device electrode”). The evaluation results are shown in Table 4.

An electrical storage device was produced and evaluated in the same manner as in Example 14, except that the positive electrode produced as described above (see “6.5.5. Production and evaluation of electrical storage device” (see Example 11)) was used as the positive electrode, and the negative electrode obtained as described above in which the protective film was formed on the surface of the active material layer was used as the negative electrode. The evaluation results are shown in Table 4.

### 6.10. Example 27 and Comparative Example 13

### 6.10.1. Synthesis of Polyimide

A polyimide was synthesized using the method disclosed in JP-A-2009-87562. Specifically, a four-necked flask equipped with a condenser and a nitrogen gas inlet was charged with 1.0 mol of 2,2-bis(3,4-dicarboxyphenyl)hexafluoropropane dianhydride, 0.95 mol of o-tolidine diisocyanate, and N-methyl-2-pyrrolidone (NMP) (solid content: 20 mass %). After the addition of 0.01 mol of diazabicycloundecene (catalyst), the mixture was stirred and reacted at 120° C. for 4 hours.

### 6.10.2. Preparation of Electrical Storage Device Composition

An electrical storage device composition (S20 and S22) was prepared in the same manner as in Example 1, except that the NMP solution of the polyimide obtained as described above was used, NMP was used instead of water, and the type and the amount of the anti-blocking agent were changed as shown in Table 7.

### 6.10.3. Preparation of Protective Film-Forming Slurry

A protective film-forming slurry was prepared in the same manner as in Example 14 (see “6.7.1. Preparation of protective film-forming slurry”), except that the electrical storage device composition S20 or S22 obtained as described above was used, and the inorganic particles shown in Table 4 were used.

### 6.10.4. Production of Positive Electrode

The protective film-forming slurry obtained as described above was applied to the surface of the active material layer of the positive electrode produced as described above (see “6.5.5. Production and evaluation of electrical storage device” (see Example 11)) using a die coating method, and dried at 120° C. for 5 minutes to form a protective film on the surface of the active material layer. The thickness of the protective film was 3 micrometers. The positive electrode was evaluated in the same manner as in Example 1 (see “6.1.4. Production and evaluation of electrical storage device electrode”). The results are shown in Table 4.

### 6.10.5. Negative Electrode

The negative electrode produced as described above (see “6.1.5. Production and evaluation of electrical storage device” (see Example 1)) was used.

### 6.10.6. Assembly of Lithium-Ion Battery Cell

An electrical storage device was produced and evaluated in the same manner as described above (see “6.1.5. Production and evaluation of electrical storage device” (see Example 1)). The results are shown in Table 4.

### 6.11. Example 28 and Comparative Example 14

80 parts by mass (on a solid basis) of the electrical storage device composition S1, 20 parts by mass (on a solid basis) of polyacrylic acid (“185012500” manufactured by ACROS, average molecular weight: 240,000), and the anti-blocking agent shown in Table 7 in the amount shown in Table 7 were mixed and stirred, and water was appropriately added to the mixture to prepare an electrical storage device composition (S21 and S23) having a solid content of 40 mass %.

A protective film-forming slurry was prepared in the same manner as described above (see “6.10. Example 27 and Comparative Example 13”), except that the electrical storage device composition S21 or S23 was used. A positive electrode in which a protective film was provided on the surface thereof was produced, and an electrical storage device was produced and evaluated in the same manner as described above (see “6.10. Example 27 and Comparative Example 13”). The results are shown in Table 4.

### 6.12. Example 29

The protective film-forming slurry prepared as described above (see “6.7.1. Preparation of protective film-forming slurry” (see Example 14) was applied to one side of a separator formed of a porous polypropylene membrane (“Celgard #2400” manufactured by Celgard LLC) using a wire bar so that the film thickness after drying was 10 micrometers, and dried at 90° C. for 20 minutes to obtain an electrical storage device separator in which a protective film was formed on the surface of a separator.

An electrical storage device electrode was produced and evaluated in the same manner as in Example 1 (see “6.1.4. Production and evaluation of electrical storage device electrode”), and an electrical storage device was produced and evaluated in the same manner as in Example 1 (see “6.1.5. Production and evaluation of electrical storage device”), except that the positive electrode produced as described above (see “6.5.5. Production and evaluation of electrical storage device” (see Example 11) and the negative electrode produced as described above (see “6.1.5. Production and evaluation of electrical storage device” (see Example 1) were used, and the electrical storage device separator was placed so that the protective film faced the positive electrode. The results are shown in Table 5.

Note that the inter-separator blocking resistance was evaluated as described below.

### <Evaluation of Inter-Separator Blocking Resistance>

Two separators produced as described above were stacked so that the protective films faced each other, and allowed to stand at 30° C. for 24 hours under a pressure of 10 g/cm². The inter-separator blocking resistance was evaluated based on the presence or absence of removal of the inorganic particles when the separators were separated. Note that the following evaluation standard was used. The evaluation results are shown in Table 5.

The inter-separator blocking resistance was evaluated as “Good” when the separators could be easily separated while preventing removal of the inorganic particles (i.e., blocking was suppressed).

The inter-separator blocking resistance was evaluated as “Bad” when the separators could not be easily separated, and removal of the inorganic particles was observed when the separators were separated (i.e., excessive blocking was observed).

### 6.13. Examples 30 to 38 and Comparative Examples 15 to 18 and 21

An electrical storage device electrode and an electrical storage device were produced and evaluated in the same manner as in Example 29, except that the protective film-forming slurry was prepared using the electrical storage device composition and the inorganic particles shown in Table 5 or 6. The results are shown in Tables 5 and 6.

### 6.14. Examples 39 to 43 and Comparative Examples 19, 20, and 22

An electrical storage device electrode and an electrical storage device were produced and evaluated in the same manner as in Example 29, except that the protective film-forming slurry was prepared using the electrical storage device composition and the inorganic particles shown in Table 6, and the electrical storage device separator was placed so that the protective film faced the negative electrode. The results are shown in Table 6.

TABLE 3

| | | Example 14 | Example 15 | Example 16 | Example 17 | Example 18 | Example 19 | Example 20 |
|---|---|---|---|---|---|---|---|---|
| Electrical storage device composition | | S1 | S2 | S3 | S4 | S5 | S8 | S9 |
| Inorganic particles | Material | Titanium | Aluminum | Zirconium | Silica | Magnesium | Titanium | Titanium |
| | | oxide | oxide | oxide | | oxide | oxide | oxide |
| | Average particle size | 0.38 | 0.74 | 0.67 | 0.54 | 0.5 | 0.08 | 0.12 |
| | (micrometers) | | | | | | | |
| Properties of | Inter-electrode | Good | Good | Good | Good | Good | Good | Good |
| electrode | blocking resistance | | | | | | | |
| | Electrode-separator | Good | Good | Good | Good | Good | Good | Good |
| | blocking resistance | | | | | | | |
| Properties of | Evaluation of charge- | Good | Good | Good | Good | Good | Good | Good |
| electrical storage | discharge rate | | | | | | | |
| device | characteristics | | | | | | | |

| | | | | | Comparative | Comparative | Comparative |
|---|---|---|---|---|---|---|---|
| | | Example 21 | Example 22 | Example 23 | Example 7 | Example 8 | Example 9 |
| Electrical storage device composition | | S10 | S6 | S7 | S11 | S12 | S13 |
| Inorganic particles | Material | Titanium | Titanium | Titanium | Titanium | Titanium | Aluminum |
| | | oxide | oxide | oxide | oxide | oxide | oxide |
| | Average particle size | 0.38 | 0.38 | 0.38 | 0.38 | 0.38 | 0.98 |
| | (micrometers) | | | | | | |
| Properties of | Inter-electrode | Good | Good | Good | Bad | Good | Bad |
| electrode | blocking resistance | | | | | | |
| | Electrode-separator | Good | Good | Good | Bad | Bad | Good |
| | blocking resistance | | | | | | |
| Properties of | Evaluation of charge- | Good | Good | Good | Bad | Bad | Bad |
| electrical storage | discharge rate | | | | | | |
| device | characteristics | | | | | | |

TABLE 4

| | | | | | Comparative | Comparative |
|---|---|---|---|---|---|---|
| | | Example 24 | Example 25 | Example 26 | Example 10 | Example 11 |
| Electrical storage device composition | | S14 | S15 | S16 | S17 | S18 |
| Inorganic particles | Material | Titanium | Titanium | Zirconium | Titanium | Titanium |
| | | oxide | oxide | oxide | oxide | oxide |
| | Average particle size | 0.38 | 0.38 | 0.67 | 0.12 | 0.12 |
| | (micrometers) | | | | | |
| Properties of | Inter-electrode | Good | Good | Good | Bad | Bad |
| electrode | blocking resistance | | | | | |
| | Electrode-separator | Good | Good | Good | Bad | Good |
| | blocking resistance | | | | | |
| Properties of | Evaluation of charge- | Good | Good | Good | Bad | Bad |
| electrical storage | discharge rate | | | | | |
| device | characteristics | | | | | |
| | | Comparative | Comparative | Comparative | | |
| | | Example 12 | Example 13 | Example 14 | Example 27 | Example 28 |
| Electrical storage device composition | | S19 | S20 | S21 | S22 | S23 |
| Inorganic particles | Material | Titanium | Titanium | Titanium | Zirconium | Zirconium |
| | | oxide | oxide | oxide | oxide | oxide |
| | Average particle size | 0.08 | 0.38 | 0.38 | 0.67 | 0.67 |
| | (micrometers) | | | | | |
| Properties of | Inter-electrode | Good | Bad | Good | Good | Good |
| electrode | blocking resistance | | | | | |
| | Electrode-separator | Bad | Good | Bad | Good | Good |
| | blocking resistance | | | | | |
| Properties of | Evaluation of charge- | Bad | Bad | Bad | Good | Good |
| electrical storage | discharge rate | | | | | |
| device | characteristics | | | | | |

TABLE 5

| | | Example 29 | Example 30 | Example 31 | Example 32 | Example 33 | Example 34 | Example 35 |
|---|---|---|---|---|---|---|---|---|
| Electrical storage device composition | | S1 | S2 | S3 | S4 | S5 | S8 | S9 |
| Inorganic particles | Material | Titanium | Aluminum | Zirconium | Silica | Magnesium | Titanium | Titanium |
| | | oxide | oxide | oxide | | oxide | oxide | oxide |
| | Average particle size | 0.38 | 0.74 | 0.67 | 0.54 | 0.5 | 0.08 | 0.12 |
| | (micrometers) | | | | | | | |
| Properties of | Inter-separator | Good | Good | Good | Good | Good | Good | Good |
| electrode | blocking resistance | | | | | | | |
| | Electrode-separator | Good | Good | Good | Good | Good | Good | Good |
| | blocking resistance | | | | | | | |
| Properties of | Evaluation of charge- | Good | Good | Good | Good | Good | Good | Good |
| electrical storage | discharge rate | | | | | | | |
| device | characteristics | | | | | | | |

| | | | | | Comparative | Comparative | Comparative |
|---|---|---|---|---|---|---|---|
| | | Example 36 | Example 37 | Example 38 | Example 15 | Example 16 | Example 17 |
| Electrical storage device composition | | S10 | S6 | S7 | S11 | S12 | S13 |
| Inorganic particles | Material | Titanium | Titanium | Titanium | Titanium | Titanium | Aluminum |
| | | oxide | oxide | oxide | oxide | oxide | oxide |
| | Average particle size | 0.38 | 0.38 | 0.38 | 0.38 | 0.38 | 0.98 |
| | (micrometers) | | | | | | |
| Properties of | Inter-separator | Good | Good | Good | Bad | Good | Bad |
| electrode | blocking resistance | | | | | | |
| | Electrode-separator | Good | Good | Good | Bad | Bad | Good |
| | blocking resistance | | | | | | |
| Properties of | Evaluation of charge- | Good | Good | Good | Bad | Bad | Bad |
| electrical storage | discharge rate | | | | | | |
| device | characteristics | | | | | | |

TABLE 6

| | | | | | Comparative | Comparative |
|---|---|---|---|---|---|---|
| | | Example 39 | Example 40 | Example 41 | Example 18 | Example 19 |
| Electrical storage device composition | | S14 | S15 | S16 | S17 | S18 |
| Inorganic particles | Material | Titanium | Titanium | Zirconium | Titanium | Titanium |
| | | oxide | oxide | oxide | oxide | oxide |
| | Average particle size | 0.38 | 0.38 | 0.67 | 0.12 | 0.12 |
| | (micrometers) | | | | | |
| Properties of | Inter-separator | Good | Good | Good | Bad | Bad |
| electrode | blocking resistance | | | | | |
| | Electrode-separator | Good | Good | Good | Bad | Good |
| | blocking resistance | | | | | |
| Properties of | Evaluation of charge- | Good | Good | Good | Bad | Bad |
| electrical storage | discharge rate | | | | | |
| device | characteristics | | | | | |
| | | Comparative | Comparative | Comparative | | |
| | | Example 20 | Example 21 | Example 22 | Example 42 | Example 43 |
| Electrical storage device composition | | S19 | S20 | S21 | S22 | S23 |
| Inorganic particles | Material | Titanium | Titanium | Titanium | Zirconium | Zirconium |
| | | oxide | oxide | oxide | oxide | oxide |
| | Average particle size | 0.08 | 0.38 | 0.38 | 0.67 | 0.67 |
| | (micrometers) | | | | | |
| Properties of | Inter-separator | Good | Bad | Good | Good | Good |
| electrode | blocking resistance | | | | | |
| | Electrode-separator | Bad | Good | Bad | Good | Good |
| | blocking resistance | | | | | |
| Properties of | Evaluation of charge- | Bad | Bad | Bad | Good | Good |
| electrical storage | discharge rate | | | | | |
| device | characteristics | | | | | |

TABLE 7

| Electrical storage device composition | | S20 | S21 | S22 | S23 |
|---|---|---|---|---|---|
| Composition of binder | | Polyimide | Mixed binder | Polyimide | Mixed binder |
| Binder content M1 (parts by mass) | | 300 | 400 | 300 | 400 |
| Anti-blocking agent content M2 | Calcium stearate (parts by mass) | — | 0.09 | — | 0.67 |
| (parts by mass) | Lithium stearate (parts by mass) | 350 | — | 1 | — |
| | Stearic acid amide (parts by mass) | — | — | — | — |
| | Polyethylene wax (parts by mass) | — | — | — | — |
| | Polypropylene wax (parts by mass) | — | — | — | — |

| | | | | |
|---|---|---|---|---|
| M1/M2 | 0.9 | 4286 | 300 | 600 |

The abbreviation of each component (used as the inorganic particles) shown in Tables 3 to 6 has the following meaning.

Titanium oxide: KR380 (manufactured by Titan Kogyo Ltd., rutile type, average particle size: 0.38 micrometers) was used directly, or KR380 was ground using an agate mortar, and classified using a sieve to prepare titanium oxide having a average particle size of 0.08 micrometers or 0.12 micrometers.

Aluminum oxide: AKP-3000 (manufactured by Sumitomo Chemical Co., Ltd., average particle size: 0.74 micrometers) or AL-160SG-3 (manufactured by Showa Denko K.K., average particle size: 0.98 micrometers) was used.

Zirconium oxide: UEP Zirconium Oxide (manufactured by Daiichi Kigenso Kagaku Kogyo Co., Ltd., average particle size: 0.67 micrometers) was used.

Silica: Seahostar (registered trademark) KE-S50 (manufactured by Nippon Shokubai Co., Ltd., average particle size: 0.54 micrometers) was used.

Magnesium oxide: PUREMAG (registered trademark) FNM-G (manufactured by Tateho Chemical Industries Co., Ltd., average particle size: 0.50 micrometers) was used.

### 6.15. Evaluation Results

As is clear from the results shown in Tables 1 to 7, the electrical storage device electrodes and the electrical storage device separators produced using the electrical storage device compositions according to the embodiments of the invention exhibited excellent blocking resistance. The electrical storage devices produced using the electrical storage device electrodes and the electrical storage device separators exhibited excellent charge-discharge characteristics.

The invention is not limited to the above embodiments. Various modifications and variations may be made of the above embodiments. The invention includes various other configurations substantially the same as the configurations described in connection with the above embodiments (such as a configuration having the same function, method, and results, or a configuration having the same objective and results). The invention also includes configurations in which an unsubstantial part (element) described in connection with the above embodiments is replaced by another part (element). The invention also includes a configuration having the same effects as those of the configurations described in connection with the above embodiments, or a configuration capable of achieving the same objective as that of the configurations described in connection with the above embodiments. The invention further includes a configuration in which a known technique is added to the configurations described in connection with the above embodiments.

### REFERENCE SIGNS LIST

10, 110: collector, 20, 120: active material layer, 30, 230: protective film, 100, 200: electrical storage device electrode, 300: electrical storage device separator

1: An electrical storage device composition comprising:
a polymer (A) that comprises a repeating unit derived from an unsaturated carboxylic ester;
a component (B) that is at least one component selected from a group consisting of a polyethylene wax, a polypropylene wax, a fatty acid amide, a fatty acid ester, and a fatty acid metal salt; and
a liquid medium,
a content (M1 parts by mass) of the polymer (A) and a content (M2 parts by mass) of the component (B) in the electrical storage device composition satisfying a relationship “1<M1/M2<4,000”.

2: An electrical storage device composition comprising a binder, an anti-blocking agent, and a liquid medium,
a content (M1 parts by mass) of the binder and a content (M2 parts by mass) of the anti-blocking agent in the electrical storage device composition satisfying a relationship “1<M1/M2<4,000”.

3: The electrical storage device composition according to claim 2, wherein the anti-blocking agent is at least one anti-blocking agent selected from a group consisting of a polyethylene wax, a polypropylene wax, a fatty acid amide, a fatty acid ester, and a fatty acid metal salt.

4: The electrical storage device composition according to claim 2, wherein the binder is a fluorine-containing binder that comprises a repeating unit (Ma) derived from a fluorine-containing ethylene-based monomer, and a repeating unit (Mb) derived from an unsaturated carboxylic ester.

5: The electrical storage device composition according to claim 2, wherein the binder is a diene-based binder that comprises a repeating unit (Mc) derived from a conjugated diene compound, a repeating unit (Md) derived from an aromatic vinyl compound, a repeating unit (Me) derived from an unsaturated carboxylic ester, and a repeating unit (Mf) derived from an unsaturated carboxylic acid.

6: The electrical storage device composition according to claim 2, wherein the binder is particles, and the particles have an average particle size of 50 to 400 nm.

7: An electrical storage device slurry comprising the electrical storage device composition according to claim 2, and an active material.

8: An electrical storage device electrode comprising a collector, and a layer that is formed by applying and drying the electrical storage device slurry according to claim 7 on a surface of the collector.

9: An electrical storage device electrode comprising a protective film that is provided on a surface of the electrical storage device electrode,
the protective film comprising:
a polymer (A) that comprises a repeating unit derived from an unsaturated carboxylic ester; and
a component (B) that is at least one component selected from a group consisting of a polyethylene wax, a polypropylene wax, a fatty acid amide, a fatty acid ester, and a fatty acid metal salt,
a content (M1 parts by mass) of the polymer (A) and a content (M2 parts by mass) of the component (B) in the protective film satisfying a relationship “1<M1/M2<4,000”.

10: An electrical storage device electrode comprising a protective film that is provided on a surface of the electrical storage device electrode,
the protective film comprising a binder and an anti-blocking agent,
a content (M1 parts by mass) of the binder and a content (M2 parts by mass) of the anti-blocking agent in the protective film satisfying a relationship “1<M1/M2<4,000”.

11: An electrical storage device slurry comprising the electrical storage device composition according to claim 2, and inorganic particles.

12: The electrical storage device slurry according to claim 11, wherein the inorganic particles are at least one type of particles selected from a group consisting of silica, titanium oxide, aluminum oxide, zirconium oxide, and magnesium oxide.

13: An electrical storage device separator comprising a layer that is formed by applying and drying the electrical storage device slurry according to claim 11 on a surface of the electrical storage device separator.

14: An electrical storage device separator comprising a protective film that is provided on a surface of the electrical storage device separator,
the protective film comprising:
a polymer (A) that comprises a repeating unit derived from an unsaturated carboxylic ester; and
a component (B) that is at least one component selected from a group consisting of a polyethylene wax, a polypropylene wax, a fatty acid amide, a fatty acid ester, and a fatty acid metal salt,
a content (M1 parts by mass) of the polymer (A) and a content (M2 parts by mass) of the component (B) in the protective film satisfying a relationship “1<M1/M2<4,000”.

15: An electrical storage device separator comprising a protective film that is provided on a surface of the electrical storage device separator,
the protective film comprising a binder and an anti-blocking agent,
a content (M1 parts by mass) of the binder and a content (M2 parts by mass) of the anti-blocking agent in the protective film satisfying a relationship “1<M1/M2<4,000”.

16: An electrical storage device comprising the electrical storage device electrode according to claim 8.

17: An electrical storage device comprising the electrical storage device separator according to claim 13.

18: An electrical storage device slurry comprising the electrical storage device composition according to claim 1, and an active material.

19: An electrical storage device electrode comprising a collector, and a layer that is formed by applying and drying the electrical storage device slurry according to claim 18 on a surface of the collector.

20: An electrical storage device slurry comprising the electrical storage device composition according to claim 1 and inorganic particles.

21: The electrical storage device slurry according to claim 20,
wherein the inorganic particles are at least one type of particles selected from a group consisting of silica, titanium oxide, aluminum oxide, zirconium oxide, and magnesium oxide.

22: An electrical storage device separator comprising a layer that is formed by applying and drying the electrical storage device slurry according to claim 20 on a surface of the electrical storage device separator.

23: An electrical storage device comprising the electrical storage device electrode according to claim 19.

24: An electrical storage device comprising the electrical storage device separator according to claim 22.
